(19) United States
(12) Patent Application Publication
(10) Pub. No.: US 2024/0283625 A1
(43) Pub. Date: Aug. 22, 2024

(54) SOUNDING REFERENCE SIGNALS IN SUB-BAND FULL DUPLEX AND NON-SUB-BAND FULL DUPLEX SYMBOLS

(71) Applicant: QUALCOMM Incorporated, San Diego, CA (US)

(72) Inventors: Muhammad Sayed Khairy ABDELGHAFFAR, San Jose, CA (US); Gokul SRIDHARAN, Sunnyvale, CA (US); Yu ZHANG, San Diego, CA (US)

(21) Appl. No.: 18/396,384

(22) Filed: Dec. 26, 2023

Related U.S. Application Data
(60) Provisional application No. 63/485,873, filed on Feb. 17, 2023.

(51) Int. Cl. H04L 5/14; H04W 72/0453

(52) U.S. Cl. CPC H04L 5/14; H04W 72/0453

(57) ABSTRACT

Various aspects of the present disclosure generally relate to wireless communication. In some aspects, a user equipment (UE) may receive a first configuration for a sounding reference signal (SRS) to be transmitted on a sub-band full duplex (SBFD) resource. The UE may receive a second configuration for the SRS to be transmitted on a non-SBFD resource. The UE may apply one of the first configuration or the second configuration based, at least in part, on whether the SRS is on one of the SBFD resource or the non-SBFD resource. Numerous other aspects are described.

### CROSS-REFERENCE TO RELATED APPLICATION

This Patent Application claims priority to U.S. Provisional Patent Application No. 63/485,873, filed on Feb. 17, 2023, entitled “SOUNDING REFERENCE SIGNALS IN SUB-BAND FULL DUPLEX AND NON-SUB-BAND FULL DUPLEX SYMBOLS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for sounding reference signal configurations for sub-band full duplex (SBFD) and non-SBFD slots or symbols.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a first configuration for a sounding reference signal (SRS) to be transmitted on a sub-band full duplex (SBFD) resource. The method may include receiving a second configuration for the SRS to be transmitted on a non-SBFD resource. The method may include applying one of the first configuration or the second configuration based, at least in part, on whether the SRS is on one of the SBFD resource or the non-SBFD resource.

Some aspects described herein relate to a method of wireless communication performed by a network node. The method may include outputting, to a UE, a first configuration for an SRS to be transmitted, by the UE, on an SBFD resource. The method may include outputting, to the UE, a second configuration for the SRS to be transmitted, by the UE, on a non-SBFD resource. The method may include configuring the UE to apply one of the first configuration or the second configuration based, at least in part, on whether the SRS is to be transmitted on one of the SBFD resource or the non-SBFD resource.

Some aspects described herein relate to a UE for wireless communication. The UE may include one or more memories and one or more processors coupled to the one or more memories. The one or more processors may be configured to receive a first configuration for an SRS to be transmitted on an SBFD resource. The one or more processors may be configured to receive a second configuration for the SRS to be transmitted on a non-SBFD resource. The one or more processors may be configured to apply one of the first configuration or the second configuration based, at least in part, on whether the SRS is on one of the SBFD resource or the non-SBFD resource.

Some aspects described herein relate to a network node for wireless communication. The network node may include one or more memories and one or more processors coupled to the one or more memories. The one or more processors may be configured to output, to a UE, a first configuration for an SRS to be transmitted, by the UE, on an SBFD resource. The one or more processors may be configured to output, to the UE, a second configuration for the SRS to be transmitted, by the UE, on a non-SBFD resource. The one or more processors may be configured to configure the UE to apply one of the first configuration or the second configuration based, at least in part, on whether the SRS is to be transmitted on one of the SBFD resource or the non-SBFD resource.

Some aspects described herein relate to a non-transitory computer-readable medium that stores a set of instructions for wireless communication by a UE. The set of instructions, when executed by one or more processors of the UE, may cause the UE to receive a first configuration for an SRS to be transmitted on an SBFD resource. The set of instructions, when executed by one or more processors of the UE, may cause the UE to receive a second configuration for the SRS to be transmitted on a non-SBFD resource. The set of instructions, when executed by one or more processors of the UE, may cause the UE to apply one of the first configuration or the second configuration based, at least in part, on whether the SRS is on one of the SBFD resource or the non-SBFD resource.

Some aspects described herein relate to a non-transitory computer-readable medium that stores a set of instructions for wireless communication by a network node. The set of instructions, when executed by one or more processors of the network node, may cause the network node to output, to a UE, a first configuration for an SRS to be transmitted, by the UE, on an SBFD resource. The set of instructions, when executed by one or more processors of the network node, may cause the network node to output, to the UE, a second configuration for the SRS to be transmitted, by the UE, on a non-SBFD resource. The set of instructions, when executed by one or more processors of the network node, may cause the network node to configure the UE to apply one of the first configuration or the second configuration based, at least in part, on whether the SRS is to be transmitted on one of the SBFD resource or the non-SBFD resource.

Some aspects described herein relate to an apparatus for wireless communication. The apparatus may include means for receiving a first configuration for an SRS to be transmitted on an SBFD resource. The apparatus may include means for receiving a second configuration for the SRS to be transmitted on a non-SBFD resource. The apparatus may include means for applying one of the first configuration or the second configuration based, at least in part, on whether the SRS is on one of the SBFD resource or the non-SBFD resource.

Some aspects described herein relate to an apparatus for wireless communication. The apparatus may include means for outputting, to a UE, a first configuration for an SRS to be transmitted, by the UE, on an SBFD resource. The apparatus may include means for outputting, to the UE, a second configuration for the SRS to be transmitted, by the UE, on a non-SBFD resource. The apparatus may include means for configuring the UE to apply one of the first configuration or the second configuration based, at least in part, on whether the SRS is to be transmitted on one of the SBFD resource or the non-SBFD resource.
Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sounding reference signal (SRS) resource sets, in accordance with the present disclosure.

FIG. 5 is a diagram illustrating an example of sub-band full duplex (SBFD) activation, in accordance with the present disclosure.

FIG. 6 is a diagram illustrating an example associated with SRS configurations for SBFD and non-SBFD slots or symbols, in accordance with the present disclosure.

FIG. 7 is a diagram illustrating an example associated with scheduling SRS configurations for SBFD and non-SBFD slots or symbols, in accordance with the present disclosure.

FIG. 8 is a diagram illustrating examples associated with aperiodic SRS configurations for SBFD and non-SBFD slots or symbols relative to a reference slot, in accordance with the present disclosure.

FIGS. 9A-9B are diagrams illustrating examples associated with frequency hopping, truncation, and the transmission of SRS on SBFD and non-SBFD slots or symbols, in accordance with the present disclosure.

FIG. 10 is a diagram illustrating an example associated with a frequency hopping pattern for SRS transmissions in SBFD and non-SBFD symbols, in accordance with the present disclosure.

FIG. 11 is a diagram illustrating an example associated with frequency hopping patterns for SBFD and non-SBFD SRS transmissions, in accordance with the present disclosure.

FIG. 12 is a diagram illustrating an example process performed, for example, by a UE, in accordance with the present disclosure.

FIG. 13 is a diagram illustrating an example process performed, for example, by a network node, in accordance with the present disclosure.

FIG. 14 is a diagram of an example apparatus for wireless communication, in accordance with the present disclosure.

FIG. 15 is a diagram of an example apparatus for wireless communication, in accordance with the present disclosure.

FIG. 16 is a diagram illustrating an example associated with an SRS configuration for SBFD and non-SBFD slots or symbols, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

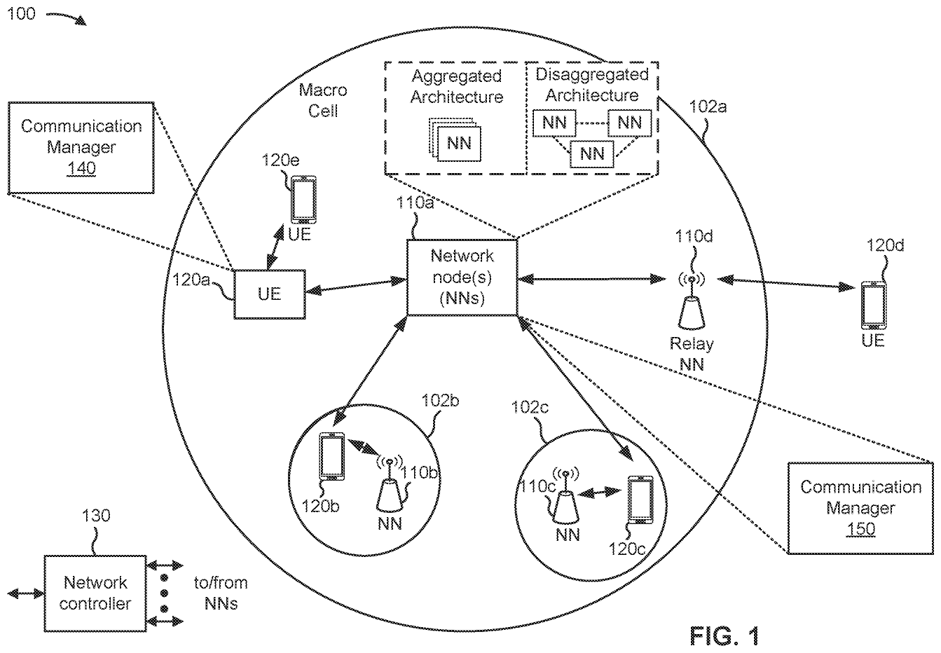

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a first configuration for a sounding reference signal (SRS) to be transmitted on a sub-band full duplex (SBFD) resource; receive a second configuration for the SRS to be transmitted on a non-SBFD resource; and apply one of the first configuration or the second configuration based, at least in part, on whether the SRS is on one of the SBFD resource or the non-SBFD resource. Additionally, or alternatively, the communication manager 140 may perform one or more other operations described herein.

In some aspects, the network node 110 may include a communication manager 150. As described in more detail elsewhere herein, the communication manager 150 may output, to a UE, a first configuration for an SRS to be transmitted, by the UE, on an SBFD resource; output, to the UE, a second configuration for the SRS to be transmitted, by the UE, on a non-SBFD resource; and configure the UE to apply one of the first configuration or the second configuration based, at least in part, on whether the SRS is to be transmitted on one of the SBFD resource or the non-SBFD resource. Additionally, or alternatively, the communication manager 150 may perform one or more other operations described herein.

As indicated above, FIG. 1 is provided as an example. Other examples may differ from what is described with regard to FIG. 1.

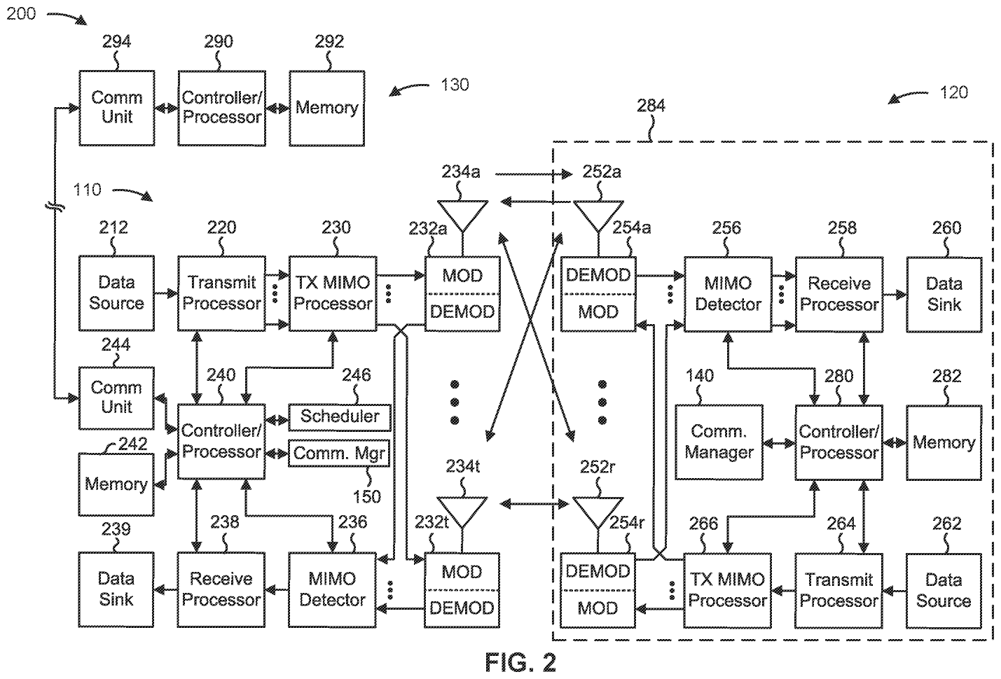

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

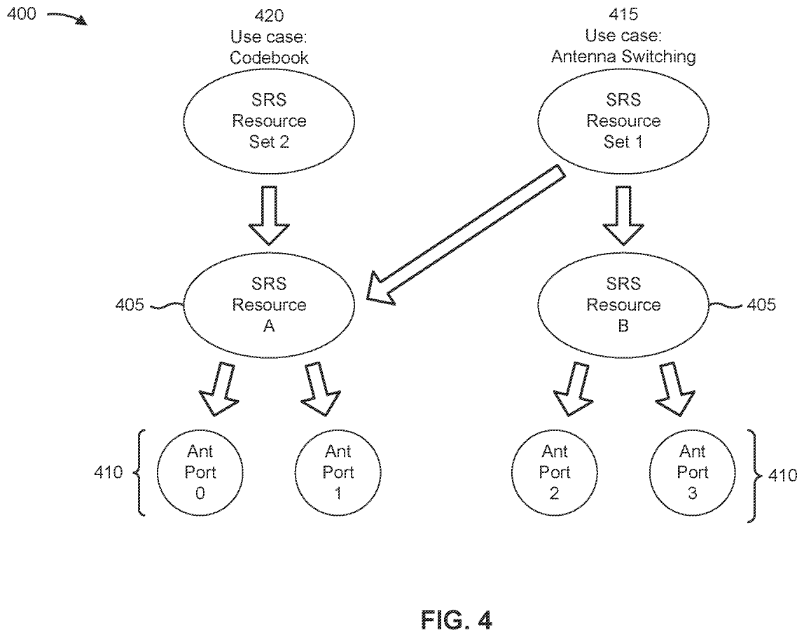

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-15).

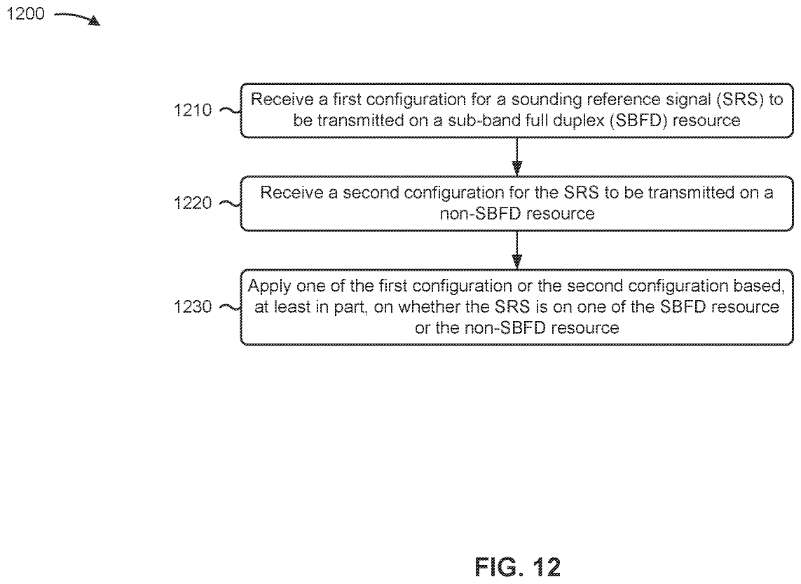

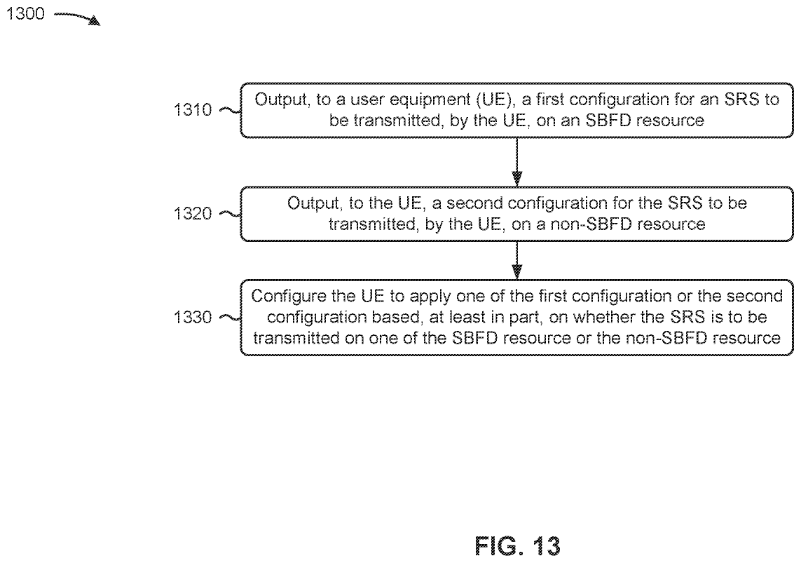

The controller/processor 240 of the network node 110, the controller/processor 280 of the UE 120, and/or any other component(s) of FIG. 2 may perform one or more techniques associated with SRS configurations for SBFD and non-SBFD symbols, as described in more detail elsewhere herein. For example, the controller/processor 240 of the network node 110, the controller/processor 280 of the UE 120, and/or any other component(s) of FIG. 2 may perform or direct operations of, for example, process 1200 of FIG. 12, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the UE 120 includes means for receiving a first configuration for an SRS to be transmitted on an SBFD resource; means for receiving a second configuration for the SRS to be transmitted on a non-SBFD resource; and/or means for applying one of the first configuration or the second configuration based, at least in part, on whether the SRS is on one of the SBFD resource or the non-SBFD resource. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for outputting, to a UE, a first configuration for an SRS to be transmitted, by the UE, on an SBFD resource; means for outputting, to the UE, a second configuration for the SRS to be transmitted, by the UE, on a non-SBFD resource; and/or means for configuring the UE to apply one of the first configuration or the second configuration based, at least in part, on whether the SRS is to be transmitted on one of the SBFD resource or the non-SBFD resource. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

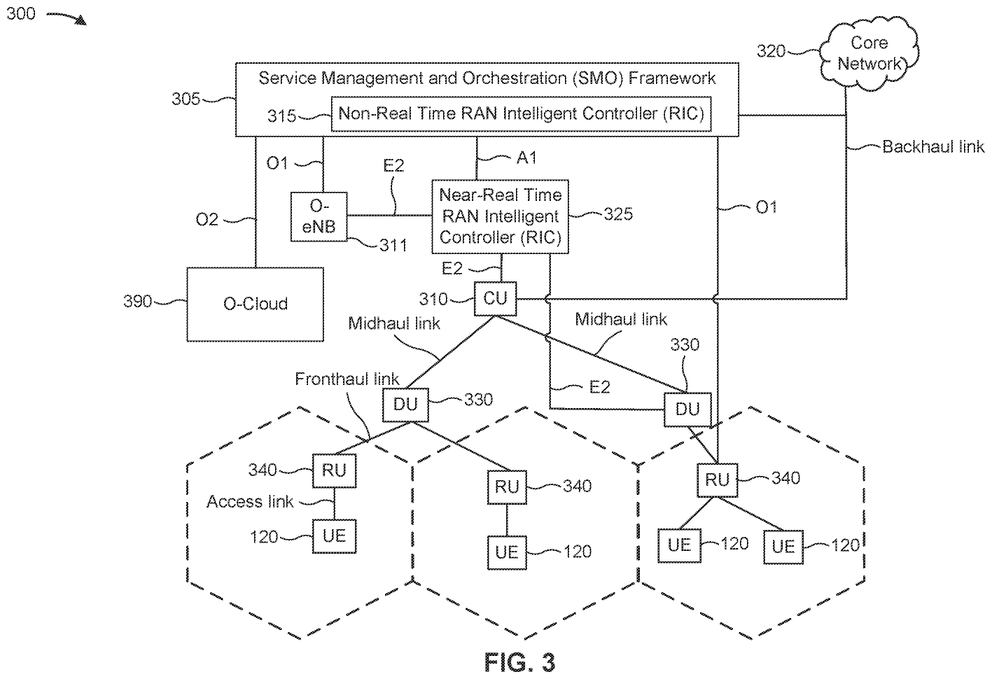

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of SRS resource sets, in accordance with the present disclosure.

A UE 120 may be configured with one or more SRS resource sets to allocate resources for SRS transmissions by the UE 120. For example, a configuration for SRS resource sets may be indicated in an RRC message (e.g., an RRC configuration message or an RRC reconfiguration message). As shown by reference number 405, an SRS resource set may include one or more resources (e.g., shown as SRS resources), which may include time resources and/or frequency resources (e.g., a slot, a symbol, a resource block, and/or a periodicity for the time resources).

As shown by reference number 410, an SRS resource may include one or more antenna ports on which an SRS is to be transmitted (e.g., in a time-frequency resource). Thus, a configuration for an SRS resource set may indicate one or more time-frequency resources in which an SRS is to be transmitted and may indicate one or more antenna ports on which the SRS is to be transmitted in those time-frequency resources. In some aspects, the configuration for an SRS resource set may indicate a use case (e.g., in an SRS-SetUse information element) for the SRS resource set. For example, an SRS resource set may have a use case of antenna switching, codebook, non-codebook, or beam management.

An antenna switching SRS resource set may be used to indicate downlink CSI with reciprocity between an uplink and downlink channel. For example, when there is reciprocity between an uplink channel and a downlink channel, a network node 110 may use an antenna switching SRS (e.g., an SRS transmitted using a resource of an antenna switching SRS resource set) to acquire downlink CSI (e.g., to determine a downlink precoder to be used to communicate with the UE 120).

A codebook SRS resource set may be used to indicate uplink CSI when a network node 110 indicates an uplink precoder to the UE 120. For example, when the network node 110 is configured to indicate an uplink precoder to the UE 120 (e.g., using a precoder codebook), the network node 110 may use a codebook SRS (e.g., an SRS transmitted using a resource of a codebook SRS resource set) to acquire uplink CSI (e.g., to determine an uplink precoder to be indicated to the UE 120 and used by the UE 120 to communicate with the network node 110). In some aspects, virtual ports (e.g., a combination of two or more antenna ports) with a maximum transmit power may be supported at least for a codebook SRS.

A non-codebook SRS resource set may be used to indicate uplink CSI when the UE 120 selects an uplink precoder (e.g., instead of the network node 110 indicated an uplink precoder to be used by the UE 120). For example, when the UE 120 is configured to select an uplink precoder, the network node 110 may use a non-codebook SRS (e.g., an SRS transmitted using a resource of a non-codebook SRS resource set) to acquire uplink CSI. In this case, the non-codebook SRS may be precoded using a precoder selected by the UE 120 (e.g., which may be indicated to the network node 110).

A beam management SRS resource set may be used for indicating CSI for millimeter wave communications.

An SRS resource can be configured as periodic, semi-persistent (sometimes referred to as semi-persistent scheduling (SPS)), or aperiodic. A periodic SRS resource may be configured via a configuration message that indicates a periodicity of the SRS resource (e.g., a slot-level periodicity, where the SRS resources occurs every Y slots) and a slot offset. In some cases, a periodic SRS resource may always be activated, and may not be dynamically activated or deactivated. A semi-persistent SRS resource may also be configured via a configuration message that indicates a periodicity and a slot offset for the semi-persistent SRS resource, and may be dynamically activated and deactivated (e.g., using DCI or a MAC control element (CE) (MAC-CE)). An aperiodic SRS resource may be triggered dynamically, such as via DCI (e.g., UE-specific DCI or group common DCI) or a MAC-CE.

In some aspects, the UE 120 may be configured with a mapping between SRS ports (e.g., antenna ports) and corresponding SRS resources. The UE 120 may transmit an SRS on a particular SRS resource using an SRS port indicated in the configuration. In some aspects, an SRS resource may span N adjacent symbols within a slot (e.g., where N equals 1, 2, or 4). The UE 120 may be configured with X SRS ports (e.g., where X≤4). In some aspects, each of the X SRS ports may mapped to a corresponding symbol of the SRS resource and used for transmission of an SRS in that symbol.

As shown in FIG. 4, in some aspects, different SRS resource sets indicated to the UE 120 (e.g., having different use cases) may overlap (e.g., in time and/or in frequency, such as in the same slot). For example, as shown by reference number 415, a first SRS resource set (e.g., shown as SRS Resource Set 1) is shown as having an antenna switching use case. As shown, this example antenna switching SRS resource set includes a first SRS resource (shown as SRS Resource A) and a second SRS resource (shown as SRS Resource B). Thus, antenna switching SRS may be transmitted in SRS Resource A (e.g., a first time-frequency resource) using antenna port 0 and antenna port 1 and may be transmitted in SRS Resource B (e.g., a second time-frequency resource) using antenna port 2 and antenna port 3.

As shown by reference number 420, a second SRS resource set (e.g., shown as SRS Resource Set 2) may be a codebook use case. As shown, this example codebook SRS resource set includes only the first SRS resource (shown as SRS Resource A). Thus, codebook SRSs may be transmitted in SRS Resource A (e.g., the first time-frequency resource) using antenna port 0 and antenna port 1. In this case, the UE 120 may not transmit codebook SRSs in SRS Resource B (e.g., the second time-frequency resource) using antenna port 2 and antenna port 3.

As indicated above, FIG. 4 is provided as an example. Other examples may differ from what is described with regard to FIG. 4.

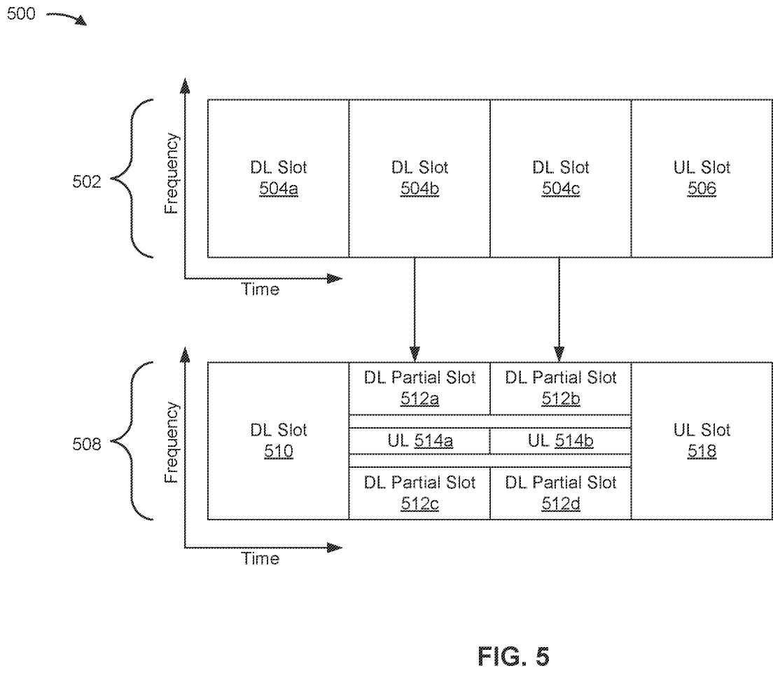

FIG. 5 is a diagram illustrating an example 500 of SBFD activation, in accordance with the present disclosure. As shown in FIG. 5, example 500 includes a first configuration 502. In some aspects, the first configuration 502 may indicate a first slot format pattern (sometimes called a time division duplex (TDD) pattern) associated with a half-duplex mode or a full-duplex mode. The first slot format pattern may include a quantity of downlink slots (e.g., three downlink slots 504a, 504b, and 504c, as shown), a quantity of flexible slots (not shown), and/or a quantity of uplink slots (e.g., one uplink slot 506, as shown). The first slot format pattern may repeat over time. In some aspects, a network node 110 may indicate the first slot format pattern to a UE 120 using one or more slot format indicators. A slot format indicator, for a slot, May indicate whether that slot is an uplink slot, a downlink slot, or a flexible slot, among other examples.

A network node 110 may instruct (e.g., using an indication, such as an RRC message, a MAC-CE, or downlink control information (DCI)) a UE 120 to switch from the first configuration 502 to a second configuration 508. As an alternative, the UE 120 may indicate to the network node 110 that the UE 120 is switching from the first configuration 502 to the second configuration 508. The second configuration 508 may indicate a second slot format pattern that repeats over time, similar to the first slot format pattern. In any of the aspects described above, the UE 120 may switch from the first configuration 502 to the second configuration 508 during a time period (e.g., a quantity of symbols and/or an amount of time (e.g., in ms)) based at least in part on an indication received from the network node 110 (e.g., before switching back to the first configuration 502). During that time period, the UE 120 may communicate using the second slot format pattern, and then may revert to using the first slot format pattern after the end of the time period. The time period may be indicated by the network node 110 (e.g., in the instruction to switch from the first configuration 502 to the second configuration 508, as described above) and/or based at least in part on a programmed and/or otherwise preconfigured rule. For example, the rule may be based at least in part on a table (e.g., defined in 3GPP specifications and/or another wireless communication standard) that associates different sub-carrier spacings (SCSs) and/or numerologies (e.g., represented by u and associated with corresponding SCSs) with corresponding time periods for switching configurations.

In example 500, the second slot format pattern includes two SBFD slots in place of what were downlink slots in the first slot format pattern. In example 500, each SBFD slot includes a partial slot (e.g., a portion or sub-band of a frequency allocated for use by the network node 110 and the UE 120) for downlink (e.g., partial slots 512a, 512b, 512c, and 512d, as shown) and a partial slot for uplink (e.g., partial slots 514a and 514b, as shown). Accordingly, the UE 120 may operate using the second slot format pattern to transmit an uplink communication in an earlier slot (e.g., the second slot in sequence, shown as partial UL slot 514a) as compared to using the first slot format pattern (e.g., the fourth slot in sequence, shown as UL slot 506). Other examples may include additional or alternative changes. For example, the second configuration 508 may indicate an SBFD slot in place of what was an uplink slot in the first configuration 502 (e.g., UL slot 506). In another example, the second configuration 508 may indicate a downlink slot or an uplink slot in place of what was an SBFD slot in the first configuration 502 (not shown in FIG. 5). In yet another example, the second configuration 508 may indicate a downlink slot 510 or an uplink slot 518 in place of what was an uplink slot or a downlink slot, respectively, in the first configuration 502. An “SBFD slot” may refer to a slot in which an SBFD format is used. An SBFD format may include a slot format in which full duplex communication is supported (e.g., for both uplink and downlink communications), with one or more frequencies used for an uplink portion of the slot being separated from one or more frequencies used for a downlink portion of the slot by a guard band. In some aspects, the SBFD format may include a single uplink portion and a single downlink portion separated by a guard band. In some aspects, the SBFD format may include multiple downlink portions and a single uplink portion that is separated from the multiple downlink portions by respective guard bands (e.g., as shown in FIG. 5). In some aspects, an SBFD format may include multiple uplink portions and a single downlink portion that is separated from the multiple uplink portions by respective guard bands. In some aspects, the SBFD format may include multiple uplink portions and multiple downlink portions, where each uplink portion is separated from a downlink portion by a guard band. In some aspects, operating using an SBFD mode may include activating or using a full duplex (FD) mode in one or more slots based at least in part on the one or more slots having the SBFD format. A slot may support the SBFD mode if a UL bandwidth part (BWP) and a DL BWP are permitted to be or are simultaneously active in the slot in an SBFD fashion (e.g., with guard band separation).

By switching from the first configuration 502 to the second configuration 508, the network node 110 and the UE 120 may experience increased quality and/or reliability of communications. For example, the network node 110 and the UE 120 may experience increased throughput (e.g., using a full-duplex mode), reduced latency (e.g., the UE 120 may be able to transmit an uplink and/or a downlink communication sooner using the second configuration 508 rather than the first configuration 502), and increased network resource utilization (e.g., by using both the DL BWP and the UL BWP simultaneously instead of only the DL BWP or the UL BWP).

As described in greater detail below, the UE 120 may be configured with multiple SRS configurations based on, for example, whether the SRS is transmitted in an SBFD slot or symbol or a non-SBFD (e.g., TDD) slot or symbol. For example, the UE 120 may be configured with a first configuration for the SRS on SBFD slots or symbols and a second configuration for SRS on non-SBFD slots or symbols.

As indicated above, FIG. 5 is provided as an example. Other examples may differ from what is described with respect to FIG. 5.

Uplink reception quality may be different between SBFD and non-SBFD (e.g., TDD) symbols. For example, the link equality in SBFD symbols may be different due to residual interference, inter-gNB interference, and/or a combination thereof, among other examples. Moreover, the gNB may have a different receiver combiner or a different receiver beam as some directions may be inhibited by interference, including cross link interference. Further, the uplink frequency resources may be different between the uplink subband (UL-SB) and the uplink span, and the UE may have different transmission powers or per-resource-block (per-RB) powers. In some examples, the receiver (uplink) panel may be different in TDD and SBFD slots, and the virtualization of port to antenna elements could be different to utilize the baseband transmitter radio unit (TxRU) more efficiently.

Some techniques and apparatuses described herein enable a UE to receive a first configuration for an SRS to be transmitted on an SBFD resource; receive a second configuration for the SRS to be transmitted on a non-SBFD resource; and apply one of the first configuration or the second configuration based, at least in part, on whether the SRS is on one of the SBFD resource or the non-SBFD resource. By applying different SRS sets and/or SRS resources for SBFD and non-SBFD slots, the UE may transmit SRS signals with a more accurate representation of the signal quality on SBFD and non-SBFD slots and/or symbols.

Some techniques and apparatuses described herein enable a network node to output, to a UE, a first configuration for an SRS to be transmitted, by the UE, on an SBFD resource; output, to the UE, a second configuration for the SRS to be transmitted, by the UE, on a non-SBFD resource; and configure the UE to apply one of the first configuration or the second configuration based, at least in part, on whether the SRS is to be transmitted on one of the SBFD resource or the non-SBFD resource. By configuring the UE with different SRS sets and/or SRS resources for SBFD and non-SBFD slots, the network node may receive SRS signals that more accurately represent the signal quality on SBFD and non-SBFD slots and/or symbols. Aspects described herein could be applicable to all SRS usages (‘codebook’, ‘non-codebook’, antenna switching of ‘beam management’). Or could be applicable to specific SRS usage (e.g. codebook and non-codebook) only.

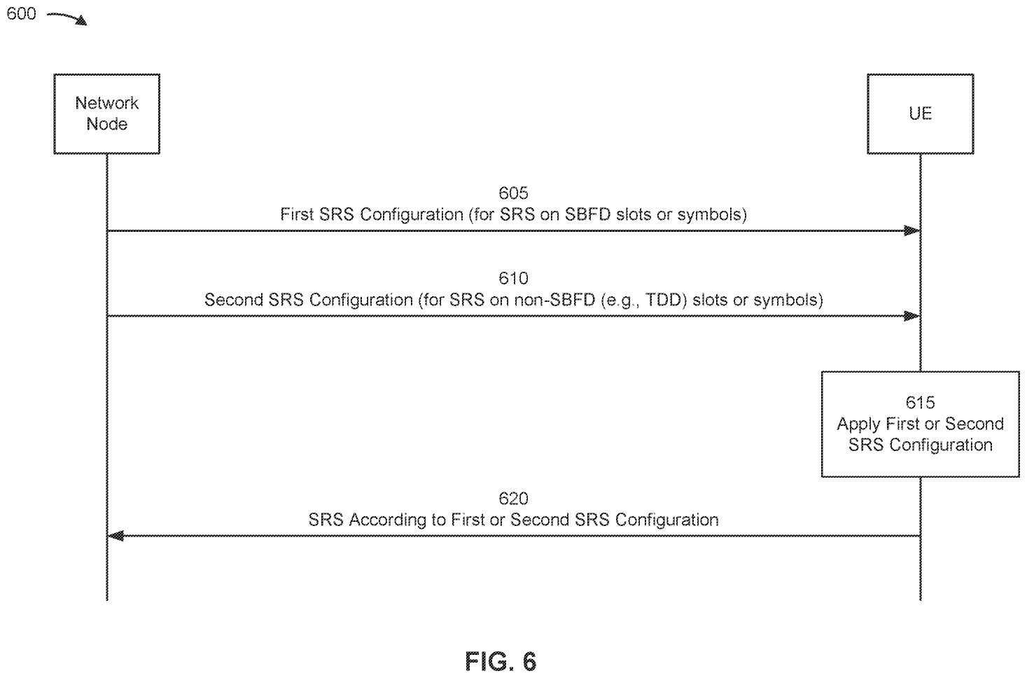

FIG. 6 is a diagram illustrating an example 600 associated with SRS configurations for SBFD and non-SBFD slots or symbols, in accordance with the present disclosure. As shown in FIG. 6, a network node (such as network node 110) and a UE (such as UE 120) may communicate with one another.

As shown by reference number 605, the network node may transmit, and the UE may receive, a first configuration for an SRS on an SBFD resource. In some aspects, the SBFD resource is an SBFD symbol with a UL-SB and a DL-SB. The first configuration may include a first SRS resource set associated with the SBFD resource. In some aspects, the first configuration includes multiple SRS resource sets associated with the SBFD resource. In some aspects, the first configuration may include a first group of SRS resources within a set and second configuration included a second group of SRS resources associated with the same SRS set.

As shown by reference number 610, the network node may transmit, and the UE may receive, a second configuration for an SRS on a non-SBFD resource (e.g., an uplink slot or symbol in a TDD configuration). In some aspects, the non-SBFD resource is a UL slot or a flexible slot. The second configuration may include a second SRS resource set associated with the non-SBFD resource. In some aspects, the second configuration includes multiple SRS resource sets associated with the non-SBFD resource.

As shown by reference number 615, the UE may apply either the first configuration or the second configuration. In some aspects, the decision to apply either the first configuration or the second configuration may be based on whether the SRS is to be transmitted on the SBFD resource or the non-SBFD resource. For example, if the SRS is to be transmitted on the SBFD resource, the UE may apply the first configuration. If the SRS is to be transmitted on the non-SBFD resource, the UE may apply the second configuration.

In some aspects, applying the first configuration may include canceling transmission of the SRS on non-SBFD resources. In some aspects, the first configuration may cause the UE to cancel transmission of the SRS on the non-SBFD resource as a result of a mismatch between a resource duplex type and a transmission occasion symbol. In some aspects, applying the first configuration and/or the second configuration may include configuring a single set with N+M SRS resources for non-SBFD and SBFD (i.e., M SRS resources specific for SBFD within the set) transmissions. Labeling the SRS resource as SBFD or non-SBFD may be based on an RRC parameter configured at the resource level.

In some aspects, applying the second configuration may include canceling transmission of the SRS on SBFD resources. In some aspects, the second configuration may cause the UE to cancel transmission of the SRS on an SBFD resource as a result of a mismatch between a resource type and a transmission occasion symbol.

In some aspects, applying the first configuration may include applying one or more of a frequency hopping pattern, a partial frequency sounding (PFS) pattern, a spatial filter, or power control to the SBFD resource.

In some aspects, applying one of the first configuration or the second configuration may include applying one or more of a frequency hopping pattern to a UL BWP.

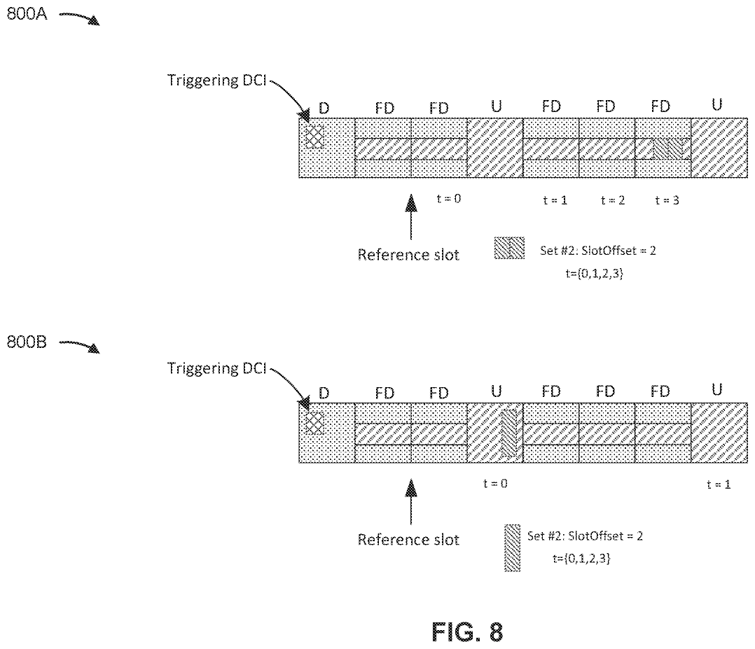

In some aspects, such as for aperiodic SRS (AP-SRS) triggering, applying the first configuration may include applying a slot offset, relative to a reference slot, associated with the SRS on the SBFD resource. The reference slot may be determined by a physical slot offset from the triggering DCI. The available slot offset (indicated by the DCI codepoint), may be counted from the reference slot as available slots based on the duplex type of slot and the triggered set, as discussed in greater detail below with respect to FIG. 8. In some aspects, the UE is configured with multiple candidate values for the reference slots, each associated with either SBFD or non-SBFD resources. In some aspects, the reference offset applied by the first configuration may be based, at least in part, on a duplex type of a downlink transmission. For example, the downlink transmission may include DCI, a physical downlink control channel (PDCCH) communication, and/or the like. In some aspects, when the UE supports the available slot offset, only available slots with the same duplex type may be counted. In some aspects, when the UE does not support available slot offsets for AP-SRS, the network node may trigger the appropriate SRS set based on the physical slot between the triggering DCI and the UL/FL slots or SBFD slots with UL subband. In that instance, the SRS may be configured with more than one slot offset, and one of the slot offsets may be selected based on the duplex type of the DCI/PDCCH.

In some aspects, the first configuration, the second configuration, and/or a combination thereof, among other examples, may be applied based, at least in part, on a duplex mode of the SRS. For example, the first configuration, the second configuration, and/or a combination thereof, among other examples, may include a configuration for SRS information for each different duplex mode. In some aspects, the same or different SRS sets/resources may apply depending on the duplex mode. In some aspects, the SRS information may be indicated by MAC-CE signaling.

In some aspects, the network node may output, and the UE may receive, DCI that triggers transmission of an aperiodic SRS resource set in a target slot. Accordingly, applying one of the first configuration or the second configuration may be based, at least in part, on a duplex type of the target slot. The UE may determine the duplex type of the target slot based, at least in part, on a bitfield in the triggering DCI. The aperiodic SRS resource set may be configured, by the UE, the network node, and/or a combination thereof, with more than one SRS triggering codepoint. Each codepoint may be associated with the first configuration or the second configuration, and determining the duplex type of the target slot may be based, at least in part, on the SRS triggering codepoint indicated by the DCI. In some aspects, a subset of the SRS resources associated with the first configuration or the second configuration may be triggered for transmission of the SRS based, at least in part, on the duplex type of the target slot.

In some aspects, applying the first configuration or the second configuration may be based, at least in part, on a duplex mode of the SRS. In some aspects, the first configuration and the second configuration may include SRS information for each different duplex mode. In some aspects, the SRS information is indicated by RRC signaling. In some aspects, the SRS information is indicated by MAC-CE signaling.

As shown by reference number 620, the UE may transmit, and the network node may receive, the SRS according to the first configuration or the second configuration. As explained above, the SRS transmitted on an SBFD resource may be transmitted according to the first configuration. The SRS transmitted on a non-SBFD resource may be transmitted according to the second configuration.

By having different SRS configurations based on whether the SRS is transmitted on an SBFD resource or a non-SBFD resource, the SRS can more accurately represent the signal quality on SBFD and non-SBFD slots and/or symbols. Accordingly, communication between the UE and the network node may be improved.

As indicated above, FIG. 6 is provided as an example. Other examples may differ from what is described with respect to FIG. 6.

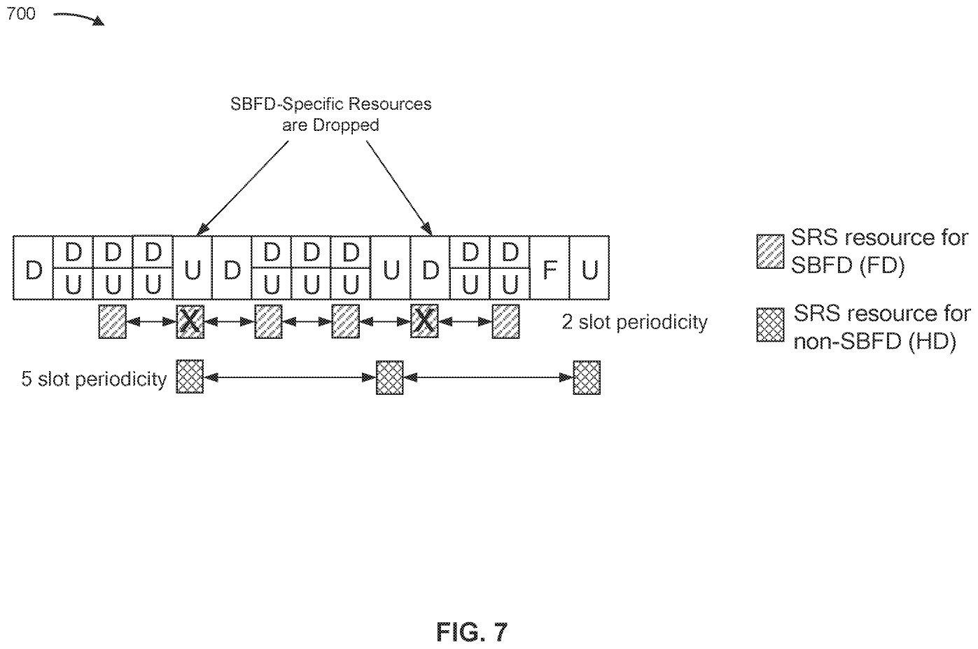

FIG. 7 is a diagram illustrating an example 700 associated with scheduling SRS configurations for SBFD and non-SBFD slots or symbols, in accordance with the present disclosure. As shown in FIG. 7, example 700 includes a first SRS configuration for SRS on SBFD slots or symbols and a second SRS configuration for SRS on non-SBFD slots or symbols. In the example 700, SRS resources for SBFD slots or symbols are scheduled with a 2-slot periodicity and SRS resources for non-SBFD slots or symbols are scheduled with a 5-slot periodicity. The SRS resource refers to periodic or semi-persistent SRS resource. Accordingly, with the first SRS configuration, the SRS may be scheduled to be transmitted by the UE during the UL-SB of every other slot, and with the second SRS configuration, the SRS may be scheduled to be transmitted by the UE during every UL slot. As shown in the example 700, with a 2-slot periodicity, the first SRS configuration schedules some of the SRS resources for SBFD slots or symbols to occur during non-SBFD slots or symbols. In those instances, the SRS resources for SBFD slots or symbols may be dropped. For example, the SRS resources for SBFD slots or symbols scheduled to occur during non-SBFD slots or symbols may be ignored.

For SBFD-specific SRS resources or sets, the frequency hopping pattern, PFS pattern, spatial filter and power control, and/or a combination thereof, among other examples, may be configured by the network node 110 to map the frequency resources of the UL-SB, proper UL beam power, and/or the like. For non-SBFD SRS resources, the frequency hopping pattern may span the UL BWP. In some instances, an RRC parameter may indicate whether the non-SBFD SRS resource or SRS set is to be transmitted on the UL-SB of SBFD slots or symbols. Accordingly, the non-SBFD SRS transmission may apply to SBFD and non-SBFD symbols if a particular frequency hop places the SRS transmission in the UL-SB of the SBFD symbol.

As indicated above, FIG. 7 is provided as an example. Other examples may differ from what is described with respect to FIG. 7.

FIG. 8 is a diagram illustrating examples 800A and 800B, respectively associated with aperiodic SRS configurations for SBFD and non-SBFD slots or symbols relative to a reference slot, in accordance with the present disclosure. If the UE 120 supports the available slot offset, available slots with the same duplex type as the duplex type of the triggered SRS set may be counted from the reference slot. Slots may be counted from the reference slot based on the available SBFD slot(s) in accordance with the first configuration (and available non-SBFD slot(s) in accordance with the second configuration). Accordingly, the UE may be configured to count only the slots with the same duplex type. The reference slot may be determined based on physical slot counting from the slot where the triggering DCI is received. Additionally, the SRS sets may be configured with two physical slot offsets, and UE may be configured to determine one of the physical slot offsets based on the slot type where the DCI is received.

In some aspects, such as where the same sets has SBFD and non-SBFD resources, e.g., M SRS resources for SBFD and N SRS resources for non-SBFD, which may occur with aperiodic SRS, the offset may be based on the reference slot and available slots counted from the reference slot. In some aspects, when this set is triggered, only a subset of the resource may be triggered for transmission, either the M resources or the N resources. The subset to be triggered may be determined based, at least in part, on some indication of the target duplex, SBFD or non-SBFD. In addition, the UE may count available slots based, at least in part, on the indicated duplex type. The available slot may be determined based on a target slot type (e.g., SBFD or non-SBFD). In some aspects, the target slot type may be indicated by a bitfield in the DCI or a specific SRS triggering codepoint (e.g., one codepoint for SBFD resources and another for non-SBFD resources). For example, when the target slot is SBFD, then an “available slot” for the SRS transmitted on the UL-SB of an SBFD resource may be a slot with SBFD symbols for the time-domain location(s) for all SBFD-specific SRS resources in the resource set and that meets the UE 120 capability on the minimum timing requirements between the triggering PDCCH and all of the SRS resources in the resource set. From the first symbol carrying the SRS request DCI to the last symbol of the triggered SRS resource set, the UE 120 does not expect to receive a slot format indicator (SFI), UL cancellation indication, or dynamic scheduling of DL channel/signal(s) on flexible symbols that may change the determination of an available slot. In another example, when target slot is non-SBFD, an “available slot” may be a UL or flexible slot for the time-domain location(s) for all non-SBFD SRS resources in the resource set and that meets the UE 120 capability on the minimum timing requirement between the triggering PDCCH and all of the SRS resources in the resource set. From the first symbol carrying the SRS request DCI to the last symbol of the triggered SRS set, the UE 120 may not expect to receive the SFI, UL cancellation indication, or dynamic scheduling of DL channel/signal(s) on flexible symbol(s) that may change the determination of an available slot.

With reference to the example 800A, the SRS set is configured with a slot offset (i.e., a reference slot) of 2 slots from the triggering DCI and configured with a list of four values of available slots (0, 1, 2, 3) where the triggering DCI selects one of them by a 2 bits codepoint. In this example, the SRS set may be transmitted with an offset of 2 slots from the triggering DCI/PDCCH and an SRS target of 1=3 (e.g., fourth available slot from the reference slot) from the reference slot. In the example 800A, only available slots of the same duplex type (e.g., full duplex) from the reference slots may be counted. Accordingly, the SRS may be transmitted at the full duplex (e.g., SBFD) slot labeled 1=3 in FIG. 8 because the slot at t=3 is the fourth full duplex available slot after the reference slot, which is an offset of 2 slots from the triggering DCI/PDCCH.

Alternatively, with reference to example 800B, the offset may be counted starting from the reference slot, counting only the non-SBFD slot (i.e. UL slot for flexible slot). As shown in the example 800B, the SRS set is configured with a slot offset (i.e., a reference slot) of 2 slots from the triggering DCI and configured with a list of four values of available slots (0, 1, 2, 3) where the triggering DCI selects one of them by a 2 bits codepoint. In this example, the SRS set may be transmitted with an offset of 2 slots from the triggering DCI/PDCCH and an SRS target of t=0 (e.g., the first available slot from the reference slot) from the reference slot. In the example 800B, UL available slots are counted from the reference slot. Accordingly, the SRS is to be transmitted at the UL slot labeled t=0 in FIG. 8 because the slot at t=0 is the first available UL slot after the reference slot, which is an offset of 2 slots from the triggering DCI/PDCCH. In another example, where DCI codepoint refer to second available slot (1=1), the second available UL slot from the reference slot is the target slot for the SRS transmission.

As indicated above, FIG. 8 is provided as an example. Other examples may differ from what is described with respect to FIG. 8.

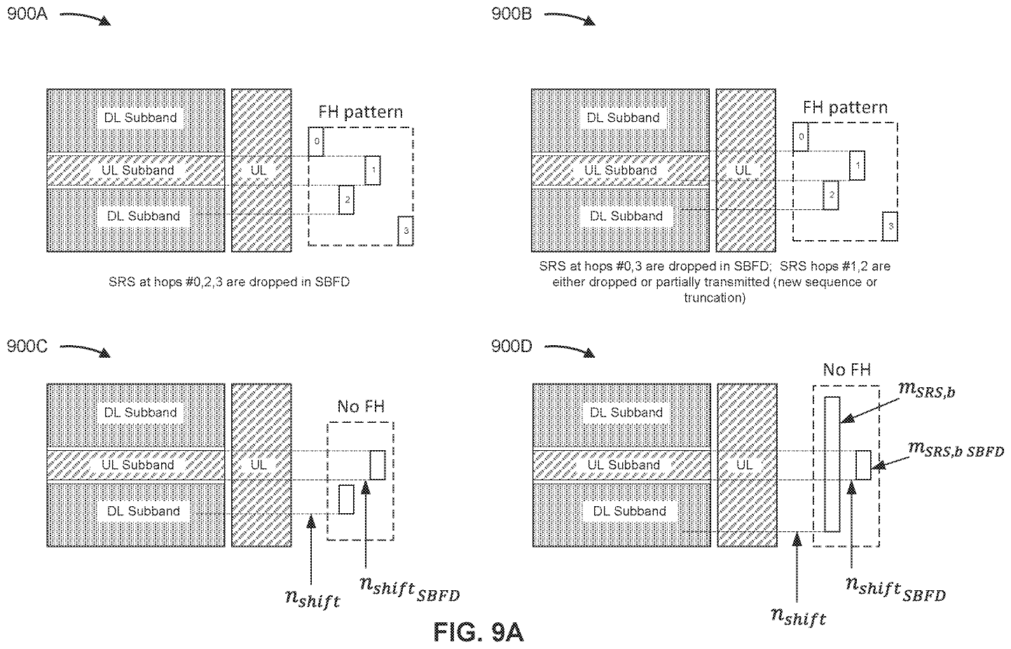

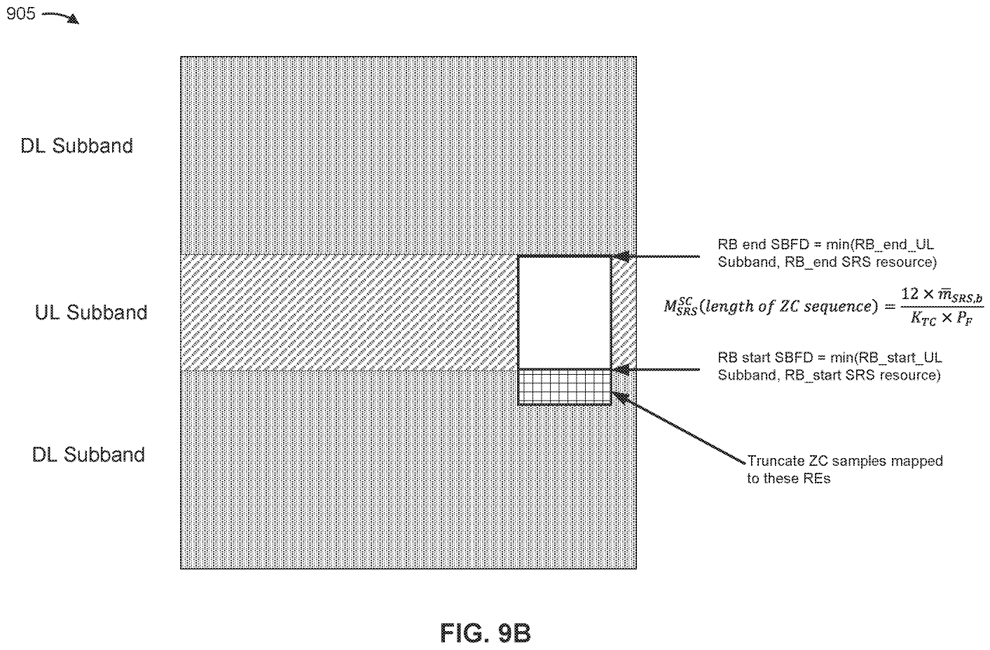

FIGS. 9A-9B are diagrams illustrating examples 900A-900D associated with frequency hopping, truncation, and the transmission of SRS on SBFD and non-SBFD slots or symbols, in accordance with the present disclosure. In instances where the same SRS resource is used for SBFD and non-SBFD symbols, the UE 120 may be configured with up to two sets of frequency configurations on the resource level (e.g., bandwidth index c-SRS,bandwidth index b-SRS, frequency hopping index b-hop, frequency domain shift, frequency domain position, among other examples).

When a single set of frequency parameters is configured (a single bandwidth m_{SRS,b}), the SRS occasions in the UL-SB may be dropped if at least one resource block falls outside the UL-SB. For example, with reference to example 900A, a frequency hopping pattern includes frequency hops 0, 1, 2, and 3. Hops 0 and 3 are completely outside the UL-SB. Hop 1 is completely within the UL-SB. Hop 2 is outside the UL-SB. In one aspect, an SBFD-based SRS transmission scheduled at hops 0, 2, and 3 may be dropped. Hop 1 may be used to transmit the SRS since it falls within the UL-SB.

In another example, such as when the resource block partially overlaps the UL-SB, the entire SRS transmission on that resource block may be dropped, a new SRS sequence based on the overlapped resources of the SRS bandwidth (m_{SRS,b}) within the UL-SB may be configured, or (as shown by example 905 in FIG. 9B), the SRS transmission may be truncated based on the available SRS. The length of the truncated SRS transmission may be defined as follows:

$$\\ {M}_{SRS}^{{}_{} SC} ( length of ZC sequence ) = \frac{12 \times {\overline{m}}_{SRS , b}}{{K}_{TC} \times {P}_{F}}$$

where K_{TC} indicates the comb pattern of the SRS and PF indicates the PFS.

In one example, with reference to example 900B in FIG. 9A, a frequency hopping pattern includes frequency hops 0, 1, 2, and 3. Hops 0 and 3 are completely outside the UL-SB. Hops 1 and 2 are both partially within the UL-SB. In one aspect, an SBFD-based SRS transmission scheduled at hops 0 and 3 may be dropped. The SBFD-based SRS may be dropped, truncated (i.e., partially transmitted) at hops 1 or 2, or transmitted in accordance with a new SRS sequence within the UL-SB.

In one example, such as where up to two values of frequency domain shift or frequency domain position are configured to a resource block, the SRS may be transmitted on a resource block defined by a single bandwidth (m_{SRS,b}) and two frequency shifts. For example, with reference to example 900C, a configuration may include a resource block defined at least in part by a first frequency shift (n_{shift}) that places the resource block at least partially outside the UL-SB, and a second frequency shift (n_{shift-SBFD}) that places the resource block within the UL-SB. The SBFD-based SRS may be transmitted on the resource block associated with the second shifted frequency. The non-SBFD-based SRS may be transmitted on the resource block associated with the first frequency shift.

In some aspects, up to two values of c-SRS may be configured to enable two SRS bandwidths (m_{SRS,b}) along with a single value of b-SRS and b-hop. For example, with reference to example 900D, a configuration may include a first resource block defined at least in part by a bandwidth (m_{SRS,b}) shifted by a first frequency shift (n_{shift}) that places the resource block within the UL band (non-SBFD). A different bandwidth (m_{SRS,b-SBFD}) shifted by a second frequency shift (n_{shift-SBFD}), which places a second resource block in the UL-SB, and the second resource block may be used for SBFD-based SRS transmissions.

As indicated above, FIGS. 9A-9B are provided as an example. Other examples may differ from what is described with respect to FIGS. 9A-9B.

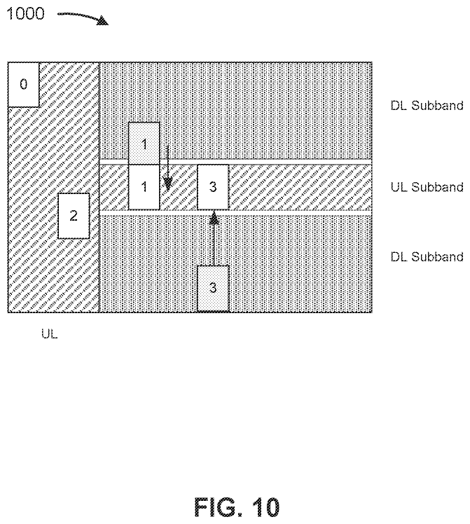

FIG. 10 is a diagram illustrating an example 1000 associated with a frequency hopping pattern for SRS transmissions in SBFD and non-SBFD symbols, in accordance with the present disclosure. In some instances, frequency hopping may not be applicable to SRS transmissions in SBFD symbols. In those instances, the UE 120 may be configured with SBFD-specific frequency resources. For example, with reference to example 1000, a frequency hopping pattern includes hops 0, 1, 2, and 3. Hops 0 and 2 occur during the UL slot of a non-SBFD resource block. Hops 1 and 3 occur during the SBFD resource block, but both hops 1 and 3 fall at least partially outside the UL-SB. Accordingly, the SBFD specific resources may shift hops 1 and 3 into the UL-SB. As indicated above, FIG. 10 is provided as an example. Other examples may differ from what is described with respect to FIG. 10.

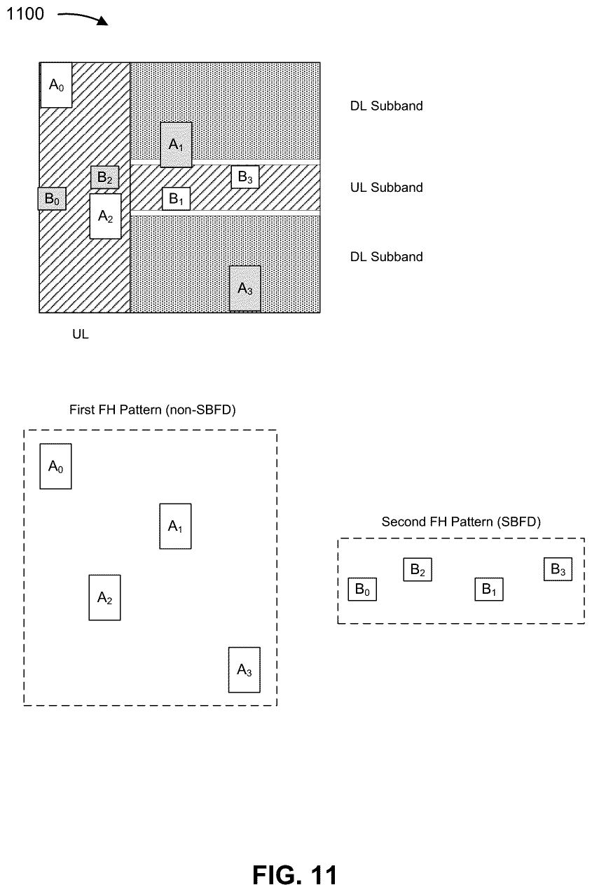

FIG. 11 is a diagram illustrating an example 1100 associated with frequency hopping patterns for SBFD and non-SBFD SRS transmissions, in accordance with the present disclosure. In some aspects, the UE 120 may be configured with multiple frequency hopping patterns. A first frequency hopping pattern may apply to non-SBFD resource blocks and a second frequency hopping pattern may apply to SBFD resource blocks. Accordingly, an SRS occasion may be transmitted on two possible candidates, and the UE 120 may select one of the candidates based, at least in part, on the corresponding symbol type.

For example, with reference to example 1100, a first frequency hopping pattern (hops A₀-A₃) may apply when the SRS is transmitted on a non-SBFD resource and a second frequency hopping pattern (hops B₀-B₃) may apply when the SRS is transmitted on an SBFD resource. In example 1100, if the SRS is to be transmitted during the UL (non-SBFD) resource block, the SRS may be transmitted on the frequency at hops A₀ or A₂. If the SRS is to be transmitted during the UL-SB of the SBFD resource, the SRS may be transmitted on the frequency at hops B₁ or B₃.

As indicated above, FIG. 11 is provided as an example. Other examples may differ from what is described with respect to FIG. 11.

FIG. 12 is a diagram illustrating an example process 1200 performed, for example, by a UE, in accordance with the present disclosure. Example process 1200 is an example where the UE (e.g., UE 120) performs operations associated with SRS configurations in SBFD and non-SBFD symbols.

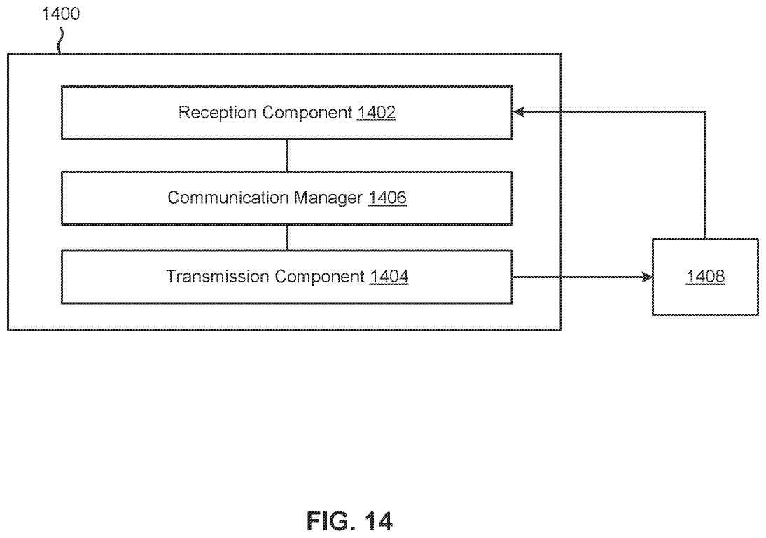

As shown in FIG. 12, in some aspects, process 1200 may include receiving a first configuration for an SRS to be transmitted on an SBFD resource (block 1210). For example, the UE (e.g., using reception component 1402 and/or communication manager 1406, depicted in FIG. 14) may receive a first configuration for an SRS to be transmitted on an SBFD resource, as described above.

As further shown in FIG. 12, in some aspects, process 1200 may include receiving a second configuration for the SRS to be transmitted on a non-SBFD resource (block 1220). For example, the UE (e.g., using reception component 1402 and/or communication manager 1406, depicted in FIG. 14) may receive a second configuration for the SRS to be transmitted on a non-SBFD resource, as described above.

As further shown in FIG. 12, in some aspects, process 1200 may include applying one of the first configuration or the second configuration based, at least in part, on whether the SRS is on one of the SBFD resource or the non-SBFD resource (block 1230). For example, the UE (e.g., using communication manager 1406, depicted in FIG. 14) may apply one of the first configuration or the second configuration based, at least in part, on whether the SRS is on one of the SBFD resource or the non-SBFD resource, as described above.

Process 1200 may include additional aspects, such as any single aspect or any combination of aspects described below and/or in connection with one or more other processes described elsewhere herein.

In a first aspect, the first configuration and the second configuration each include multiple SRS resource sets, wherein each SRS resource set is associated with the SBFD resource or the non-SBFD resource.

In a second aspect, alone or in combination with the first aspect, the first configuration and the second configuration each include multiple SRS resources within a single resource set, wherein each SRS resource is associated with the SBFD resource or the non-SBFD resource.

In a third aspect, alone or in combination with one or more of the first and second aspects, applying one of the first configuration or the second configuration includes canceling transmission of the SRS on the non-SBFD resource in accordance with the first configuration.

In a fourth aspect, alone or in combination with one or more of the first through third aspects, applying one of the first configuration or the second configuration includes canceling transmission of the SRS on the SBFD resource in accordance with the second configuration.

In a fifth aspect, alone or in combination with one or more of the first through fourth aspects, the non-SBFD resource is an uplink slot or a flexible slot.

In a sixth aspect, alone or in combination with one or more of the first through fifth aspects, the SBFD resource is an SBFD symbol with a UL-SB and a downlink subband (DL-SB).

In a seventh aspect, alone or in combination with one or more of the first through sixth aspects, applying one of the first configuration or the second configuration includes canceling transmission of the SRS on the non-SBFD resource as a result of a mismatch between a resource type and a transmission occasion symbol.

In an eighth aspect, alone or in combination with one or more of the first through seventh aspects, applying one of the first configuration or the second configuration includes canceling transmission of the SRS on the SBFD resource as a result of a mismatch between a resource type and a transmission occasion symbol.

In a ninth aspect, alone or in combination with one or more of the first through eighth aspects, applying one of the first configuration or the second configuration includes applying one or more of a frequency hopping pattern, a partial frequency sounding pattern, a spatial filter, or power control to the SBFD resource.

In a tenth aspect, alone or in combination with one or more of the first through ninth aspects, applying one of the first configuration or the second configuration includes applying a frequency hopping pattern to an uplink bandwidth part.

In an eleventh aspect, alone or in combination with one or more of the first through tenth aspects, applying one of the first configuration or the second configuration includes applying a slot offset, relative to a reference slot, associated with the SRS on the SBFD resource.

In a twelfth aspect, alone or in combination with one or more of the first through eleventh aspects, process 1200 includes receiving DCI that triggers transmission of an aperiodic SRS resource set in a slot, and applying one of the first configuration or the second configuration is based, at least in part, on a duplex type associated with the aperiodic SRS resource set.

In a thirteenth aspect, alone or in combination with one or more of the first through twelfth aspects, process 1200 includes determining the slot based, at least in part, on a reference slot relative to the slot at which the triggering DCI was received.

In a fourteenth aspect, alone or in combination with one or more of the first through thirteenth aspects, process 1200 includes determining the reference slot based, at least in part, on a duplex type of the slot at which the triggering DCI was received.

In a fifteenth aspect, alone or in combination with one or more of the first through fourteenth aspects, the slot is based, at least in part, on an offset from the reference slot based, at least in part, on a count of a number of slots with the same duplex type of the aperiodic SRS resource set.

In a sixteenth aspect, alone or in combination with one or more of the first through fifteenth aspects, process 1200 includes receiving DCI that triggers transmission of an aperiodic SRS resource set in a target slot, and applying one of the first configuration or the second configuration is based, at least in part, on a duplex type of the target slot.

In a seventeenth aspect, alone or in combination with one or more of the first through sixteenth aspects, process 1200 includes determining the duplex type of the target slot based, at least in part, on a bitfield in the triggering DCI.

In an eighteenth aspect, alone or in combination with one or more of the first through seventeenth aspects, process 1200 includes determining the duplex type of the target slot based, at least in part, on the SRS triggering codepoint indicated by the DCI. In a nineteenth aspect, alone or in combination with one or more of the first through eighteenth aspects, a subset of SRS resources associated with the first configuration or the second configuration is triggered for transmission of the SRS based, at least in part, on the duplex type of the target slot.

In a twentieth aspect, alone or in combination with one or more of the first through nineteenth aspects, process 1200 includes receiving up to two frequency configurations for an SRS resource.

In a twenty-first aspect, alone or in combination with one or more of the first through twentieth aspects, process 1200 includes receiving the first configuration and the second configuration as a shared configuration for the SRS resource and canceling transmission of the SRS in a UL-SB as a result of one or more resource blocks being outside the UL-SB.

In a twenty-second aspect, alone or in combination with one or more of the first through twenty-first aspects, process 1200 includes applying a new SRS sequence based, at least in part, on overlapped resources within a UL-SB.

In a twenty-third aspect, alone or in combination with one or more of the first through twenty-second aspects, process 1200 includes truncating an SRS sequence.

In a twenty-fourth aspect, alone or in combination with one or more of the first through twenty-third aspects, applying the first configuration or the second configuration includes configuring up to two frequency domain shift values or frequency domain position values.

In a twenty-fifth aspect, alone or in combination with one or more of the first through twenty-fourth aspects, the up to two frequency domain shift values shift a frequency of the SRS to a frequency of a UL-SB.

In a twenty-sixth aspect, alone or in combination with one or more of the first through twenty-fifth aspects, applying the first configuration or the second configuration includes configuring up to two SRS sequence length values configured to enable up to two SRS bandwidth values, wherein at least one of the SRS bandwidth values is within a UL-SB.

In a twenty-seventh aspect, alone or in combination with one or more of the first through twenty-sixth aspects, applying the first configuration or the second configuration includes applying frequency hopping to SRS transmissions scheduled on non-SBFD resources and shifting SRS transmissions scheduled on non-SBFD symbols to frequencies within a UL-SB.

In a twenty-eighth aspect, alone or in combination with one or more of the first through twenty-seventh aspects, applying the first configuration or the second configuration includes applying a first frequency hopping pattern to SRS transmissions scheduled on SBFD resources and a second frequency hopping pattern to SRS transmissions scheduled on non-SBFD resources, wherein frequencies in the second frequency hopping pattern are within a UL-SB.

In a twenty-ninth aspect, alone or in combination with one or more of the first through twenty-eighth aspects, applying the first configuration or the second configuration is based, at least in part, on a duplex mode of the SRS.

In a thirtieth aspect, alone or in combination with one or more of the first through twenty-ninth aspects, applying the first configuration or the second configuration includes configuring SRS information for each different duplex mode.

In a thirty-first aspect, alone or in combination with one or more of the first through thirtieth aspects, the SRS information is indicated by radio resource control signaling.

In a thirty-second aspect, alone or in combination with one or more of the first through thirty-first aspects, the SRS information is indicated by MAC-CE signaling.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., network node 110) performs operations associated with SRS configurations in SBFD and non-SBFD symbols.

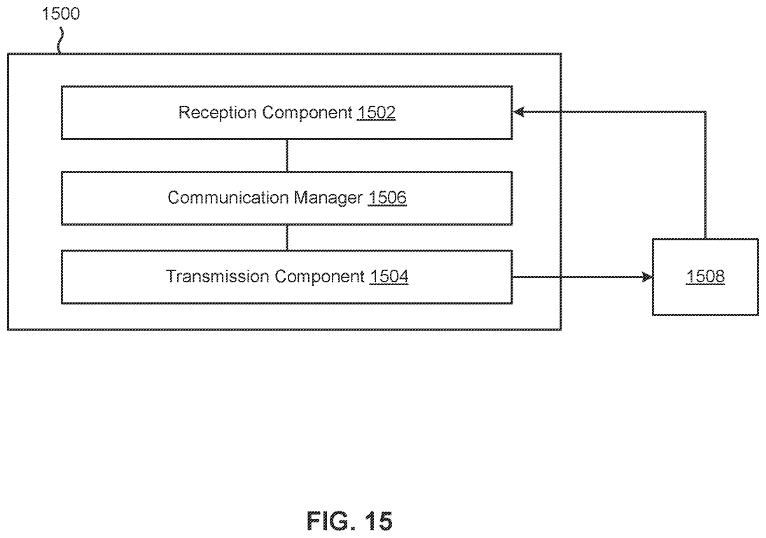

As shown in FIG. 13, in some aspects, process 1300 may include outputting, to a UE, a first configuration for an SRS to be transmitted, by the UE, on an SBFD resource (block 1310). For example, the network node (e.g., using transmission component 1504 and/or communication manager 1506, depicted in FIG. 15) may output, to a UE, a first configuration for an SRS to be transmitted, by the UE, on an SBFD resource, as described above.

As further shown in FIG. 13, in some aspects, process 1300 may include outputting, to the UE, a second configuration for the SRS to be transmitted, by the UE, on a non-SBFD resource (block 1320). For example, the network node (e.g., using transmission component 1504 and/or communication manager 1506, depicted in FIG. 15) may output, to the UE, a second configuration for the SRS to be transmitted, by the UE, on a non-SBFD resource, as described above.

As further shown in FIG. 13, in some aspects, process 1300 may include configuring the UE to apply one of the first configuration or the second configuration based, at least in part, on whether the SRS is to be transmitted on one of the SBFD resource or the non-SBFD resource (block 1330). For example, the network node (e.g., using communication manager 1506, depicted in FIG. 15) may configure the UE to apply one of the first configuration or the second configuration based, at least in part, on whether the SRS is to be transmitted on one of the SBFD resource or the non-SBFD resource, as described above.

Process 1300 may include additional aspects, such as any single aspect or any combination of aspects described below and/or in connection with one or more other processes described elsewhere herein.

In a first aspect, the first configuration and the second configuration each include multiple SRS resource sets, wherein each SRS resource set is associated with the SBFD resource or the non-SBFD resource.

In a second aspect, alone or in combination with the first aspect, the first configuration and the second configuration each include multiple SRS resources within a single resource set, wherein each SRS resource is associated with the SBFD resource or the non-SBFD resource.

In a third aspect, alone or in combination with one or more of the first and second aspects, configuring the UE to apply one of the first configuration or the second configuration includes configuring the UE to cancel transmission of the SRS on the non-SBFD resource in accordance with the first configuration.

In a fourth aspect, alone or in combination with one or more of the first through third aspects, configuring the UE to apply one of the first configuration or the second configuration includes configuring the UE to cancel transmission of the SRS on the SBFD resource in accordance with the second configuration.

In a fifth aspect, alone or in combination with one or more of the first through fourth aspects, the non-SBFD resource is an uplink slot or a flexible slot.

In a sixth aspect, alone or in combination with one or more of the first through fifth aspects, the SBFD resource is an SBFD symbol with a UL-SB and a DL-SB.

In a seventh aspect, alone or in combination with one or more of the first through sixth aspects, configuring the UE to apply one of the first configuration or the second configuration includes configuring the UE to cancel transmission of the SRS on the non-SBFD resource as a result of a mismatch between a resource type and a transmission occasion symbol.

In an eighth aspect, alone or in combination with one or more of the first through seventh aspects, configuring the UE to apply one of the first configuration or the second configuration includes configuring the UE to cancel transmission of the SRS on the SBFD resource as a result of a mismatch between resource type and a transmission occasion symbol.

In a ninth aspect, alone or in combination with one or more of the first through eighth aspects, configuring the UE to apply one of the first configuration or the second configuration includes configuring the UE to apply one or more of a frequency hopping pattern, a partial frequency sounding pattern, a spatial filter, or power control to the SBFD resource.

In a tenth aspect, alone or in combination with one or more of the first through ninth aspects, configuring the UE to apply one of the first configuration or the second configuration includes configuring the UE to apply a frequency hopping pattern to an uplink bandwidth part.

In an eleventh aspect, alone or in combination with one or more of the first through tenth aspects, configuring the UE to apply one of the first configuration or the second configuration includes configuring the UE to apply a slot offset, relative to a reference slot, associated with the SRS on the SBFD resource.

In a twelfth aspect, alone or in combination with one or more of the first through eleventh aspects, process 1300 includes outputting or configuring DCI that causes the UE to transmit an aperiodic SRS resource set in a slot, and configuring the UE to apply one of the first configuration or the second configuration is based, at least in part, on a duplex type associated with the aperiodic SRS resource set.

In a thirteenth aspect, alone or in combination with one or more of the first through twelfth aspects, process 1300 includes configuring the UE to determine the slot based, at least in part, on a reference slot relative to the slot at which the triggering DCI was received.

In a fourteenth aspect, alone or in combination with one or more of the first through thirteenth aspects, process 1300 includes configuring the UE to determine the reference slot based, at least in part, on a duplex type of the slot at which the triggering DCI was received.

In a fifteenth aspect, alone or in combination with one or more of the first through fourteenth aspects, the slot is based, at least in part, on an offset from the reference slot based, at least in part, on a count of a number of slots with the same duplex type of the aperiodic SRS resource set.

In a sixteenth aspect, alone or in combination with one or more of the first through fifteenth aspects, process 1300 includes outputting or configuring DCI that triggers transmission of an aperiodic SRS resource set in a target slot, and applying one of the first configuration or the second configuration is based, at least in part, on a duplex type of the target slot.

In a seventeenth aspect, alone or in combination with one or more of the first through sixteenth aspects, process 1300 includes configuring the UE to determine the duplex type of the target slot based, at least in part, on a bitfield in the triggering DCI.

In an eighteenth aspect, alone or in combination with one or more of the first through seventeenth aspects, process 1300 includes determining the duplex type of the target slot based, at least in part, on the SRS triggering codepoint indicated by the DCI.

In a nineteenth aspect, alone or in combination with one or more of the first through eighteenth aspects, a subset of SRS resources associated with the first configuration or the second configuration is triggered for transmission of the SRS based, at least in part, on the duplex type of the target slot.

In a twentieth aspect, alone or in combination with one or more of the first through nineteenth aspects, process 1300 includes configuring the UE to receive up to two frequency configurations for an SRS resource.

In a twenty-first aspect, alone or in combination with one or more of the first through twentieth aspects, process 1300 includes configuring the UE to receive the first configuration and the second configuration as a shared configuration for the SRS resource and cancel transmission of the SRS in a UL-SB as a result of one or more resource blocks being outside the UL-SB.

In a twenty-second aspect, alone or in combination with one or more of the first through twenty-first aspects, process 1300 includes configuring the UE to apply a new SRS sequence based, at least in part, on overlapped resources within a UL-SB.

In a twenty-third aspect, alone or in combination with one or more of the first through twenty-second aspects, process 1300 includes configuring the UE to truncate an SRS sequence.

In a twenty-fourth aspect, alone or in combination with one or more of the first through twenty-third aspects, configuring the UE to apply one of the first configuration or the second configuration includes configuring the UE to apply up to two frequency domain shift values or frequency domain position values.

In a twenty-fifth aspect, alone or in combination with one or more of the first through twenty-fourth aspects, the up to two frequency domain shift values shift a frequency of the SRS to a frequency of a UL-SB.

In a twenty-sixth aspect, alone or in combination with one or more of the first through twenty-fifth aspects, configuring the UE to apply one of the first configuration or the second configuration includes configuring the UE to apply up to two SRS sequence length values configured to enable up to two SRS bandwidth values, wherein at least one of the SRS bandwidth values is within a UL-SB.

In a twenty-seventh aspect, alone or in combination with one or more of the first through twenty-sixth aspects, configuring the UE to apply one of the first configuration or the second configuration includes configuring the UE to apply frequency hopping to SRS transmissions scheduled on non-SBFD resources and shifting SRS transmissions scheduled on non-SBFD symbols to frequencies within a UL-SB.

In a twenty-eighth aspect, alone or in combination with one or more of the first through twenty-seventh aspects, configuring the UE to apply one of the first configuration or the second configuration includes configuring the UE to apply a first frequency hopping pattern to SRS transmissions scheduled on SBFD resources and a second frequency hopping pattern to SRS transmissions scheduled on non-SBFD resources, wherein frequencies in the second frequency hopping pattern are within a UL-SB.

In a twenty-ninth aspect, alone or in combination with one or more of the first through twenty-eighth aspects, the first configuration or the second configuration is based, at least in part, on a duplex mode of the SRS.

In a thirtieth aspect, alone or in combination with one or more of the first through twenty-ninth aspects, configuring the UE to apply one of the first configuration or the second configuration includes configuring the UE to configure SRS information for each different duplex mode.

In a thirty-first aspect, alone or in combination with one or more of the first through thirtieth aspects, the SRS information is indicated by radio resource control signaling.

In a thirty-second aspect, alone or in combination with one or more of the first through thirty-first aspects, the SRS information is indicated by MAC-CE signaling.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 140 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 4-11. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive a first configuration for an SRS to be transmitted on an SBFD resource. The reception component 1402 may receive a second configuration for the SRS to be transmitted on a non-SBFD resource. The communication manager 1406 may apply one of the first configuration or the second configuration based, at least in part, on whether the SRS is on one of the SBFD resource or the non-SBFD resource.

The reception component 1402 may receive DCI that triggers transmission of an aperiodic SRS resource set in a slot, and applying one of the first configuration or the second configuration may be based, at least in part, on a duplex type associated with the aperiodic SRS resource set.

The communication manager 1406 may determine the slot based, at least in part, on a reference slot relative to the slot at which the triggering DCI was received.

The communication manager 1406 may determine the reference slot based, at least in part, on a duplex type of the slot at which the triggering DCI was received.

The reception component 1402 may receive DCI that triggers transmission of an aperiodic SRS resource set in a target slot, and applying one of the first configuration or the second configuration may be based, at least in part, on a duplex type of the target slot.

The communication manager 1406 may determine the duplex type of the target slot based, at least in part, on a bitfield in the triggering DCI.

The communication manager 1406 may determine the duplex type of the target slot based, at least in part, on the SRS triggering codepoint indicated by the DCI.

The reception component 1402 may receive up to two frequency configurations for an SRS resource.

The reception component 1402 may receive the first configuration and the second configuration as a shared configuration for the SRS resource and cancel transmission of the SRS in a UL-SB as a result of one or more resource blocks being outside the UL-SB.

The communication manager 1406 may apply a new SRS sequence based, at least in part, on overlapped resources within a UL-SB.

The communication manager 1406 may truncate an SRS sequence.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 4-11. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The transmission component 1504 may output, to a UE, a first configuration for an SRS to be transmitted, by the UE, on an SBFD resource. The transmission component 1504 may output, to the UE, a second configuration for the SRS to be transmitted, by the UE, on a non-SBFD resource. The communication manager 1506 may configure the UE to apply one of the first configuration or the second configuration based, at least in part, on whether the SRS is to be transmitted on one of the SBFD resource or the non-SBFD resource.

The transmission component 1504 may output or configure DCI that causes the UE to transmit an aperiodic SRS resource set in a slot, and configuring the UE to apply one of the first configuration or the second configuration may be based, at least in part, on a duplex type associated with the aperiodic SRS resource set.

The communication manager 1506 may configure the UE to determine the slot based, at least in part, on a reference slot relative to the slot at which the triggering DCI was received.

The communication manager 1506 may configure the UE to determine the reference slot based, at least in part, on a duplex type of the slot at which the triggering DCI was received.

The transmission component 1504 may output or configure DCI that triggers transmission of an aperiodic SRS resource set in a target slot, and applying one of the first configuration or the second configuration may be based, at least in part, on a duplex type of the target slot.

The communication manager 1506 may configure the UE to determine the duplex type of the target slot based, at least in part, on a bitfield in the triggering DCI.

The communication manager 1506 may determine the duplex type of the target slot based, at least in part, on the SRS triggering codepoint indicated by the DCI.

The communication manager 1506 may configure the UE to receive up to two frequency configurations for an SRS resource.

The communication manager 1506 may configure the UE to receive the first configuration and the second configuration as a shared configuration for the SRS resource and cancel transmission of the SRS in a UL-SB as a result of one or more resource blocks being outside the UL-SB.

The communication manager 1506 may configure the UE to apply a new SRS sequence based, at least in part, on overlapped resources within a UL-SB.

The communication manager 1506 may configure the UE to truncate an SRS sequence.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

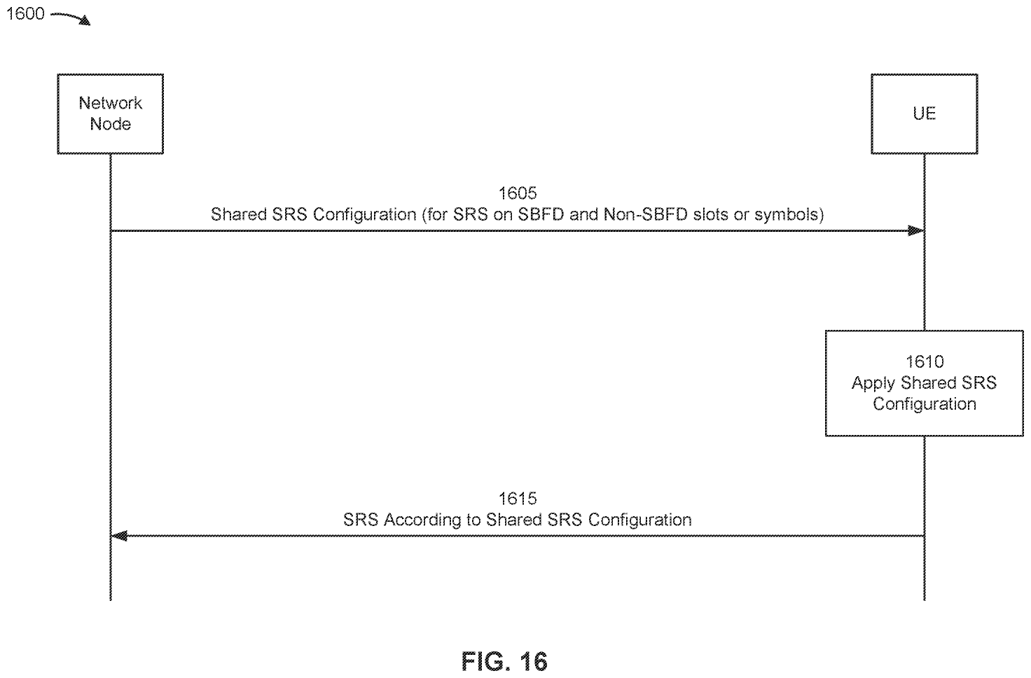

FIG. 16 is a diagram illustrating an example 1600 associated with SRS configurations for SBFD and non-SBFD slots or symbols, in accordance with the present disclosure. As shown in FIG. 16, a network node (such as network node 110) and a UE (such as UE 120) may communicate with one another.

As shown by reference number 1605, the network node may transmit, and the UE may receive, a shared configuration for an SRS on an SBFD and non-SBFD resource. The configuration refers to one or more SRS resource sets with multiple SRS resource. In some aspects, the SBFD resource is an SBFD symbol with a UL-SB and a DL-SB. In some aspects, the non-SBFD resource is a UL slot or a flexible slot.

As shown by reference number 1610, the UE may apply the shared configuration. In some aspects, applying the shared configuration for SBFD and non-SBFD may include canceling transmission of the SRS in the UL-SB as a result of one or more resource blocks being outside the UL-SB. In some aspects, applying the shared configuration may include applying a new SRS sequence based, at least in part, on overlapped resources within the UL-SB. In some aspects, the shared configuration may include a configuration of up to two frequency domain shift values or frequency domain position values. The frequency domain shift values may shift a frequency of the SRS to a frequency of the UL-SB. In some aspects, the shared configuration may include a configuration of up to two SRS length values configured to enable up to two SRS bandwidth values. At least one of the SRS bandwidth values may be within the UL-SB. In some aspects, applying the shared configuration may configure the UE to apply a frequency hopping pattern to SRS transmissions scheduled on non-SBFD resources. In some aspects, applying the frequency hopping pattern may include shifting the SRS transmissions scheduled on non-SBFD resources to frequencies within the UL-SB. In some aspects, a first frequency hopping pattern may be applied to SRS transmissions scheduled on SBFD resources and a second frequency hopping pattern may be applied to SRS transmissions scheduled on non-SBFD resources. In some aspects, frequencies in the second frequency hopping pattern may be in the UL-SB.

In some aspects, the network node may output, and the UE may receive, up to two frequency configurations for the SRS resource. In aspects where only one shared configuration is output by the network node and/or received by the UE, the transmission of the SRS in the UL-SB may be canceled as a result of one or more resource blocks being outside the UL-SB. In some aspects, a new SRS sequence may be based, at least in part, on overlapped resources within the UL-SB. In some aspects, an SRS sequence may be truncated to, for example, fit within the UL-SB. In some aspects, up to two frequency domain shift values or frequency domain position values may be configured. The frequency domain shift values or frequency domain position values may shift a frequency of the SRS to a frequency of the UL-SB. In some aspects, two SRS sequence length values may be configured to enable up to two SRS bandwidth values, at least one of which may be within the UL-SB. In some aspects, when frequency hopping may be applied to the SRS transmissions scheduled on non-SBFD resources, the SRS transmissions scheduled on non-SBFD symbols may be shifted to frequencies within the UL-SB. Alternatively, in some aspects, a first frequency hopping pattern, with frequencies within the UL-SB, may be applied to SRS transmissions scheduled on SBFD resources and a second frequency hopping pattern may be applied to SRS transmissions scheduled on non-SBFD resources.

As shown by reference number 1615, the UE may transmit, and the network node may receive, the SRS according to the shared configuration.

As indicated above, FIG. 16 is provided as an example. Other examples may differ from what is described with respect to FIG. 16.

The following provides an overview of some Aspects of the present disclosure:
Aspect 1: A method of wireless communication performed by a UE, comprising: receiving a first configuration for an SRS to be transmitted on an SBFD resource; receiving a second configuration for the SRS to be transmitted on a non-SBFD resource; and applying one of the first configuration or the second configuration based, at least in part, on whether the SRS is on one of the SBFD resource or the non-SBFD resource.
Aspect 2: The method of Aspect 1, wherein the first configuration and the second configuration each include multiple SRS resource sets, wherein each SRS resource set is associated with the SBFD resource or the non-SBFD resource.
Aspect 3: The method of any of Aspects 1-2, wherein the first configuration and the second configuration each include multiple SRS resources within a single resource set, wherein each SRS resource is associated with the SBFD resource or the non-SBFD resource.
Aspect 4: The method of any of Aspects 1-3, wherein applying one of the first configuration or the second configuration includes canceling transmission of the SRS on the non-SBFD resource in accordance with the first configuration.
Aspect 5: The method of any of Aspects 1-4, wherein applying one of the first configuration or the second configuration includes canceling transmission of the SRS on the SBFD resource in accordance with the second configuration.
Aspect 6: The method of any of Aspects 1-5, wherein the non-SBFD resource is an uplink slot or a flexible slot.
Aspect 7: The method of any of Aspects 1-6, wherein the SBFD resource is an SBFD symbol with a UL-SB and a DL-SB.
Aspect 8: The method of any of Aspects 1-7, wherein applying one of the first configuration or the second configuration includes canceling transmission of the SRS on the non-SBFD resource as a result of a mismatch between a resource type and a transmission occasion symbol.
Aspect 9: The method of any of Aspects 1-8, wherein applying one of the first configuration or the second configuration includes canceling transmission of the SRS on the SBFD resource as a result of a mismatch between a resource type and a transmission occasion symbol.
Aspect 10: The method of any of Aspects 1-9, wherein applying one of the first configuration or the second configuration includes applying one or more of a frequency hopping pattern, a partial frequency sounding pattern, a spatial filter, or power control to the SBFD resource.
Aspect 11: The method of any of Aspects 1-10, wherein applying one of the first configuration or the second configuration includes applying a frequency hopping pattern to an uplink bandwidth part.
Aspect 12: The method of any of Aspects 1-11, wherein applying one of the first configuration or the second configuration includes applying a slot offset, relative to a reference slot, associated with the SRS on the SBFD resource.
Aspect 13: The method of any of Aspects 1-12, further comprising receiving DCI that triggers transmission of an aperiodic SRS resource set in a slot, and wherein applying one of the first configuration or the second configuration is based, at least in part, on a duplex type associated with the aperiodic SRS resource set.
Aspect 14: The method of Aspect 13, further comprising determining the slot based, at least in part, on a reference slot relative to the slot at which the triggering DCI was received.
Aspect 15: The method of Aspect 14, further comprising determining the reference slot based, at least in part, on a duplex type of the slot at which the triggering DCI was received.
Aspect 16: The method of Aspect 14, wherein the slot is based, at least in part, on an offset from the reference slot based, at least in part, on a count of a number of slots with the same duplex type of the aperiodic SRS resource set.
Aspect 17: The method of any of Aspects 1-16, further comprising receiving DCI that triggers transmission of an aperiodic SRS resource set in a target slot, and wherein applying one of the first configuration or the second configuration is based, at least in part, on a duplex type of the target slot.
Aspect 18: The method of Aspect 17, further comprising determining the duplex type of the target slot based, at least in part, on a bitfield in the triggering DCI.
Aspect 19: The method of Aspect 17, further comprising configuring the aperiodic SRS resource set with more than one SRS triggering codepoints, wherein each codepoint is associated with the first configuration or the second configuration, the method further comprising determining the duplex type of the target slot based, at least in part, on the SRS triggering codepoint indicated by the DCI.
Aspect 20: The method of Aspect 17, wherein a subset of SRS resources associated with the first configuration or the second configuration is triggered for transmission of the SRS based, at least in part, on the duplex type of the target slot.
Aspect 21: The method of any of Aspects 1-20, further comprising receiving up to two frequency configurations for an SRS resource.
Aspect 22: The method of Aspect 21, further comprising receiving the first configuration and the second configuration as a shared configuration for the SRS resource and canceling transmission of the SRS in a UL-SB as a result of one or more resource blocks being outside the UL-SB.
Aspect 23: The method of Aspect 21, further comprising applying a new SRS sequence based, at least in part, on overlapped resources within a UL-SB.
Aspect 24: The method of Aspect 21, further comprising truncating an SRS sequence.
Aspect 25: The method of Aspect 21, wherein applying the first configuration or the second configuration includes configuring up to two frequency domain shift values or frequency domain position values.
Aspect 26: The method of Aspect 21, wherein the up to two frequency domain shift values shift a frequency of the SRS to a frequency of a UL-SB.
Aspect 27: The method of Aspect 21, wherein applying the first configuration or the second configuration includes configuring up to two SRS sequence length values configured to enable up to two SRS bandwidth values, wherein at least one of the SRS bandwidth values is within a UL-SB.
Aspect 28: The method of Aspect 21, wherein applying the first configuration or the second configuration includes applying frequency hopping to SRS transmissions scheduled on non-SBFD resources and shifting SRS transmissions scheduled on non-SBFD symbols to frequencies within a UL-SB.
Aspect 29: The method of any of Aspects 1-28, wherein applying the first configuration or the second configuration includes applying a first frequency hopping pattern to SRS transmissions scheduled on SBFD resources and a second frequency hopping pattern to SRS transmissions scheduled on non-SBFD resources, wherein frequencies in the second frequency hopping pattern are within a UL-SB.
Aspect 30: The method of any of Aspects 1-29, wherein applying the first configuration or the second configuration is based, at least in part, on a duplex mode of the SRS.
Aspect 31: The method of Aspect 30, wherein applying the first configuration or the second configuration includes configuring SRS information for each different duplex mode.
Aspect 32: The method of Aspect 31, wherein the SRS information is indicated by radio resource control signaling.
Aspect 33: The method of Aspect 31, wherein the SRS information is indicated by MAC-CE signaling.
Aspect 34: A method of wireless communication performed by a network node, comprising: outputting, to a UE, a first configuration for an SRS to be transmitted, by the UE, on an SBFD resource; outputting, to the UE, a second configuration for the SRS to be transmitted, by the UE, on a non-SBFD resource; and configuring the UE to apply one of the first configuration or the second configuration based, at least in part, on whether the SRS is to be transmitted on one of the SBFD resource or the non-SBFD resource.
Aspect 35: The method of Aspect 34, wherein the first configuration and the second configuration each include multiple SRS resource sets, wherein each SRS resource set is associated with the SBFD resource or the non-SBFD resource.
Aspect 36: The method of any of Aspects 34-35, wherein the first configuration and the second configuration each include multiple SRS resources within a single resource set, wherein each SRS resource is associated with the SBFD resource or the non-SBFD resource.
Aspect 37: The method of any of Aspects 34-36, wherein configuring the UE to apply one of the first configuration or the second configuration includes configuring the UE to cancel transmission of the SRS on the non-SBFD resource in accordance with the first configuration.
Aspect 38: The method of any of Aspects 34-37, wherein configuring the UE to apply one of the first configuration or the second configuration includes configuring the UE to cancel transmission of the SRS on the SBFD resource in accordance with the second configuration.
Aspect 39: The method of any of Aspects 34-38, wherein the non-SBFD resource is an uplink slot or a flexible slot.
Aspect 40: The method of any of Aspects 34-39, wherein the SBFD resource is an SBFD symbol with a UL-SB and a DL-SB.
Aspect 41: The method of any of Aspects 34-40, wherein configuring the UE to apply one of the first configuration or the second configuration includes configuring the UE to cancel transmission of the SRS on the non-SBFD resource as a result of a mismatch between a resource type and a transmission occasion symbol.
Aspect 42: The method of any of Aspects 34-41, wherein configuring the UE to apply one of the first configuration or the second configuration includes configuring the UE to cancel transmission of the SRS on the SBFD resource as a result of a mismatch between a resource type and a transmission occasion symbol.
Aspect 43: The method of any of Aspects 34-42, wherein configuring the UE to apply one of the first configuration or the second configuration includes configuring the UE to apply one or more of a frequency hopping pattern, a partial frequency sounding pattern, a spatial filter, or power control to the SBFD resource.
Aspect 44: The method of any of Aspects 34-43, wherein configuring the UE to apply one of the first configuration or the second configuration includes configuring the UE to apply a frequency hopping pattern to an uplink bandwidth part.
Aspect 45: The method of any of Aspects 34-44, wherein configuring the UE to apply one of the first configuration or the second configuration includes configuring the UE to apply a slot offset, relative to a reference slot, associated with the SRS on the SBFD resource.
Aspect 46: The method of any of Aspects 34-45, further comprising outputting or configuring DCI that causes the UE to transmit an aperiodic SRS resource set in a slot, and wherein configuring the UE to apply one of the first configuration or the second configuration is based, at least in part, on a duplex type associated with the aperiodic SRS resource set.
Aspect 47: The method of Aspect 46, further comprising configuring the UE to determine the slot based, at least in part, on a reference slot relative to the slot at which the triggering DCI was received.
Aspect 48: The method of Aspect 47, further comprising configuring the UE to determine the reference slot based, at least in part, on a duplex type of the slot at which the triggering DCI was received.
Aspect 49: The method of Aspect 47, wherein the slot is based, at least in part, on an offset from the reference slot based, at least in part, on a count of a number of slots with the same duplex type of the aperiodic SRS resource set.
Aspect 50: The method of any of Aspects 34-49, further comprising outputting or configuring DCI that triggers transmission of an aperiodic SRS resource set in a target slot, and wherein applying one of the first configuration or the second configuration is based, at least in part, on a duplex type of the target slot.
Aspect 51: The method of Aspect 50, further comprising configuring the UE to determine the duplex type of the target slot based, at least in part, on a bitfield in the triggering DCI.
Aspect 52: The method of Aspect 50, further comprising configuring the UE to configure the aperiodic SRS resource set with more than one SRS triggering codepoints, wherein each codepoint is associated with the first configuration or the second configuration, the method further comprising determining the duplex type of the target slot based, at least in part, on the SRS triggering codepoint indicated by the DCI.
Aspect 53: The method of Aspect 50, wherein a subset of SRS resources associated with the first configuration or the second configuration is triggered for transmission of the SRS based, at least in part, on the duplex type of the target slot.
Aspect 54: The method of any of Aspects 34-53, further comprising configuring the UE to receive up to two frequency configurations for an SRS resource.
Aspect 55: The method of Aspect 54, further comprising configuring the UE to receive the first configuration and the second configuration as a shared configuration for the SRS resource and cancel transmission of the SRS in a UL-SB as a result of one or more resource blocks being outside the UL-SB.
Aspect 56: The method of Aspect 54, further comprising configuring the UE to apply a new SRS sequence based, at least in part, on overlapped resources within a UL-SB.
Aspect 57: The method of Aspect 54, further comprising configuring the UE to truncate an SRS sequence.
Aspect 58: The method of Aspect 54, wherein configuring the UE to apply one of the first configuration or the second configuration includes configuring the UE to apply up to two frequency domain shift values or frequency domain position values.
Aspect 59: The method of Aspect 54, wherein the up to two frequency domain shift values shift a frequency of the SRS to a frequency of a UL-SB.
Aspect 60: The method of Aspect 54, wherein configuring the UE to apply one of the first configuration or the second configuration includes configuring the UE to apply up to two SRS sequence length values configured to enable up to two SRS bandwidth values, wherein at least one of the SRS bandwidth values is within a UL-SB.
Aspect 61: The method of Aspect 54, wherein configuring the UE to apply one of the first configuration or the second configuration includes configuring the UE to apply frequency hopping to SRS transmissions scheduled on non-SBFD resources and shifting SRS transmissions scheduled on non-SBFD symbols to frequencies within a UL-SB.
Aspect 62: The method of any of Aspects 34-61, wherein configuring the UE to apply one of the first configuration or the second configuration includes configuring the UE to apply a first frequency hopping pattern to SRS transmissions scheduled on SBFD resources and a second frequency hopping pattern to SRS transmissions scheduled on non-SBFD resources, wherein frequencies in the second frequency hopping pattern are within a UL-SB.
Aspect 63: The method of any of Aspects 34-62, wherein the first configuration or the second configuration is based, at least in part, on a duplex mode of the SRS.
Aspect 64: The method of Aspect 63, wherein configuring the UE to apply one of the first configuration or the second configuration includes configuring the UE to configure SRS information for each different duplex mode.
Aspect 65: The method of Aspect 64, wherein the SRS information is indicated by radio resource control signaling.
Aspect 66: The method of Aspect 64, wherein the SRS information is indicated by MAC-CE signaling.
Aspect 67: An apparatus for wireless communication at a device, comprising a processor; memory coupled with the processor; and instructions stored in the memory and executable by the processor to cause the apparatus to perform the method of one or more of Aspects 1-66.
Aspect 68: A device for wireless communication, comprising a memory and one or more processors coupled to the memory, the one or more processors configured to perform the method of one or more of Aspects 1-66.
Aspect 69: An apparatus for wireless communication, comprising at least one means for performing the method of one or more of Aspects 1-66.
Aspect 70: A non-transitory computer-readable medium storing code for wireless communication, the code comprising instructions executable by a processor to perform the method of one or more of Aspects 1-66.
Aspect 71: A non-transitory computer-readable medium storing a set of instructions for wireless communication, the set of instructions comprising one or more instructions that, when executed by one or more processors of a device, cause the device to perform the method of one or more of Aspects 1-66.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to:
receive a first configuration for a sounding reference signal (SRS) to be transmitted on a sub-band full duplex (SBFD) resource;
receive a second configuration for the SRS to be transmitted on a non-SBFD resource; and
apply one of the first configuration or the second configuration based, at least in part, on whether the SRS is on one of the SBFD resource or the non-SBFD resource.

2. The UE of claim 1, wherein the first configuration and the second configuration each include multiple SRS resource sets, wherein each SRS resource set is associated with the SBFD resource or the non-SBFD resource.

3. The UE of claim 1, wherein the one or more processors, to apply one of the first configuration or the second configuration, are configured to cancel transmission of the SRS on the non-SBFD resource in accordance with the first configuration.

4. The UE of claim 1, wherein the one or more processors, to apply one of the first configuration or the second configuration, are configured to cancel transmission of the SRS on the SBFD resource in accordance with the second configuration.

5. The UE of claim 1, wherein the non-SBFD resource is an uplink slot or a flexible slot.

6. The UE of claim 1, wherein the SBFD resource is an SBFD symbol with an uplink subband and a downlink subband.

7. The UE of claim 1, wherein the one or more processors, to apply one of the first configuration or the second configuration, are configured to apply one or more of a frequency hopping pattern, a partial frequency sounding pattern, a spatial filter, or power control to the SBFD resource.

8. The UE of claim 1, wherein the one or more processors, to apply one of the first configuration or the second configuration, are configured to apply a frequency hopping pattern to an uplink bandwidth part.

9. The UE of claim 1, wherein the one or more processors, to apply one of the first configuration or the second configuration, are configured to apply a slot offset, relative to a reference slot, associated with the SRS on the SBFD resource.

10. The UE of claim 1, wherein the one or more processors are further configured to receive downlink control information (DCI) that triggers transmission of an aperiodic SRS resource set in a slot, and wherein applying one of the first configuration or the second configuration is based, at least in part, on a duplex type associated with the aperiodic SRS resource set.

11. The UE of claim 10, wherein the one or more processors are further configured to determine the slot based, at least in part, on a reference slot relative to the slot at which the triggering DCI was received.

12. The UE of claim 11, wherein the one or more processors are further configured to determine the reference slot based, at least in part, on a duplex type of the slot at which the triggering DCI was received.

13. The UE of claim 11, wherein the slot is based, at least in part, on an offset from the reference slot based, at least in part, on a count of a number of slots with the same duplex type of the aperiodic SRS resource set.

14. The UE of claim 1, wherein the one or more processors are further configured to receive up to two frequency configurations for an SRS resource.

15. The UE of claim 14, wherein the one or more processors are further configured to receive the first configuration and the second configuration as a shared configuration for the SRS resource and cancel transmission of the SRS in an uplink subband as a result of one or more resource blocks being outside the uplink subband.

16. The UE of claim 14, wherein the one or more processors are further configured to apply a new SRS sequence based, at least in part, on overlapped resources within an uplink subband.

17. The UE of claim 14, wherein the one or more processors are further configured to truncate an SRS sequence.

18. The UE of claim 14, wherein the one or more processors, to apply the first configuration or the second configuration, are configured to configuring up to two frequency domain shift values or frequency domain position values.

19. The UE of claim 14, wherein the up to two frequency domain shift values shift a frequency of the SRS to a frequency of an uplink subband.

20. The UE of claim 14, wherein applying the first configuration or the second configuration includes configuring up to two SRS sequence length values configured to enable up to two SRS bandwidth values, wherein at least one of the SRS bandwidth values is within an uplink subband.

21. The UE of claim 14, wherein the one or more processors, to apply the first configuration or the second configuration, are configured to apply frequency hopping to SRS transmissions scheduled on non-SBFD resources and shifting SRS transmissions scheduled on non-SBFD symbols to frequencies within an uplink subband.

22. The UE of claim 1, wherein applying the first configuration or the second configuration includes applying a first frequency hopping pattern to SRS transmissions scheduled on SBFD resources and a second frequency hopping pattern to SRS transmissions scheduled on non-SBFD resources, wherein frequencies in the second frequency hopping pattern are within an uplink subband.

23. The UE of claim 1, wherein applying the first configuration or the second configuration is based, at least in part, on a duplex mode of the SRS.

24. A network node for wireless communication, comprising:
one or more memories; and
one or more processors, coupled to the memory, configured to:
output, to a user equipment (UE), a first configuration for a sounding reference signal (SRS) to be transmitted, by the UE, on a sub-band full duplex (SBFD) resource;
output, to the UE, a second configuration for the SRS to be transmitted, by the UE, on a non-SBFD resource; and
configure the UE to apply one of the first configuration or the second configuration based, at least in part, on whether the SRS is to be transmitted on one of the SBFD resource or the non-SBFD resource.

25. The network node of claim 24, wherein the first configuration and the second configuration each include multiple SRS resource sets, wherein each SRS resource set is associated with the SBFD resource or the non-SBFD resource.

26. The network node of claim 24, wherein the one or more processors, to configure the UE to apply one of the first configuration or the second configuration, are configured to configure the UE to cancel transmission of the SRS on the non-SBFD resource in accordance with the first configuration.

27. The network node of claim 24, wherein the one or more processors, to configure the UE to apply one of the first configuration or the second configuration, are configured to configure the UE to cancel transmission of the SRS on the SBFD resource in accordance with the second configuration.

28. The network node of claim 24, wherein the one or more processors are further configured to configure the UE to receive up to two frequency configurations for an SRS resource, and
wherein the one or more processors are further configured to configure the UE to receive the first configuration and the second configuration as a shared configuration for the SRS resource and cancel transmission of the SRS in an uplink subband as a result of one or more resource blocks being outside the uplink subband.

29. A method of wireless communication performed by a user equipment (UE), comprising:
receiving a first configuration for a sounding reference signal (SRS) to be transmitted on a sub-band full duplex (SBFD) resource;
receiving a second configuration for the SRS to be transmitted on a non-SBFD resource; and
applying one of the first configuration or the second configuration based, at least in part, on whether the SRS is on one of the SBFD resource or the non-SBFD resource.

30. A method of wireless communication performed by a network node, comprising:
outputting, to a user equipment (UE), a first configuration for a sounding reference signal (SRS) to be transmitted, by the UE, on a sub-band full duplex (SBFD) resource;
outputting, to the UE, a second configuration for the SRS to be transmitted, by the UE, on a non-SBFD resource; and
configuring the UE to apply one of the first configuration or the second configuration based, at least in part, on whether the SRS is to be transmitted on one of the SBFD resource or the non-SBFD resource.
